(19) United States
(12) Patent Application Publication
(10) Pub. No.: US 2012/0209748 A1
(43) Pub. Date: Aug. 16, 2012

(54) DEVICES, SYSTEMS, AND METHODS FOR PROVIDING GIFT SELECTION AND GIFT REDEMPTION SERVICES IN AN E-COMMERCE ENVIRONMENT OVER A COMMUNICATION NETWORK

(75) Inventor: Margaret Small, State College, PA (US)

(73) Assignee: THE PENN STATE RESEARCH FOUNDATION, University Park, PA (US)

(21) Appl. No.: 13/371,472

(22) Filed: Feb. 12, 2012

Related U.S. Application Data
(60) Provisional application No. 61/442,227, filed on Feb. 12, 2011.

(51) Int. Cl. G06Q 30/06

(52) U.S. Cl. 705/27.1

(57) ABSTRACT

Systems, devices, and methods for providing gift selection and gift redemption services in an e-commerce environment over a communication network. Such systems, devices, and methods (i) provide gift recipient attributes and gift experience attributes to a gift donor communication interface; and (ii) receive a selection of gift recipient attributes and gift experience attributes from a communication interface. Further, the systems, devices, and methods provide gift options using a matching algorithm based on the gift recipient attributes and gift experience attributes to the communication interface. In addition, systems, devices, and methods: (i) receive more selected gift options from the communication interface; (ii) generate and provide reveal experiences to the communication interface; (iii) receive selected reveal experiences from the communication interface; and (iii) provide a gift redemption code based on the selected gift option and the selected reveal experience to the communication interface.

### CROSS-REFERENCE TO RELATED APPLICATIONS

The present application claims priority under the laws and rules of the United States, including 35 USC §120, to U.S. Provisional Patent Application No. 61/442,227 filed on Feb. 12, 2011. The contents of U.S. Provisional Patent Application No. 61/442,227 is herein incorporated by reference.

### BACKGROUND

The Internet as well as current web, networking, and mobile technologies have provided a platform for E-commerce between business and consumers as well from business to business. The technology for the consumer segment of e-commerce has been evolving to adapt to the consumer needs and desires. One aspect of the consumer segment of e-commerce has been providing promotional codes, gift redemption codes, gift cards/codes, or any other code or key to consumers to use to redeem on an e-commerce website (or other software application—e.g. mobile) to select and purchase a product or service. Conventional e-commerce processes and systems provide a consumer a straightforward manner to enter a promotional code, gift redemption code, gift cards/code, or any other code or key into a user interface of a client device coupled to a computer server hosting an e-commerce website or other software application (e.g. mobile software application). A gift card/code may be associated with a specific amount of money such that a redeemer of the gift card/code may purchase one or more products or services offered by the e-commerce website (up to the specific amount of money). Alternatively, the gift card/code may be associated with a specific product or service chosen by a gift donor. After receiving the code or key, the e-commerce website may reveal to the consumer the product or service selected by the gift donor to redeem, based on the code. For example, a gift code may allow a consumer to or redeem or purchase a DVD player on an electronics seller's e-commerce website.

### SUMMARY

Aspects of the present disclosure allow a consumer or gift donor to purchase a promotional code, gift redemption code, gift cards code, or any other code or key from an e-commerce website (or other software application—e.g. mobile) as well as select a gift and/or a gift reveal experience based on attributes of the gift and the gift recipient. Further, a gift recipient when redeeming the promotional code, gift redemption code, gift cards/code, or any other code or key, may view the reveal experience selected by the gift donor. The purchase of the gift code/gift card and the selection of the gift reveal as well as the redemption of the gift code and viewing of the gift reveal may be from an e-commerce website or other software application hosted on a computer server (e.g. mobile application server). Alternatively, the gift card may be purchased from a brick and mortar store to be redeemed and otherwise used in conjunction with a gift selection and redemption provider's website.

Within the embodiments disclosed are systems, devices and methods for providing gift selection and gift redemption services in an e-commerce environment over a communication network. Such systems, devices, and methods may include a computer server having one or more server communication interfaces coupled to the communication network and one or more server processors coupled to one or more server storage devices. A computer server may have a selection software engine stored in the one or more server storage devices and executed by one or more server processors. Further, the selection software engine may provide one or more gift recipient attributes and one or more gift experience attributes to a gift donor communication interface. In addition, the selection software engine may receive one or more donor selected gift recipient attributes and one or more donor selected gift experience attributes from the gift donor communication interface.

The computer server may also have a matching software engine stored in the one or more server storage devices and executed by one or more server processors. The matching software engine may provide one or more matched gift options based on the donor selected gift recipient attributes and the donor selected gift experience attributes to the gift donor communication interface.

The computer server may further have a reveal software engine stored in the one or more server storage devices and executed by one or more server processors. In addition, the reveal software engine may receive one or more selected matched gift options from a gift donor communication interface. Further, the reveal software engine may generate and provide one or more reveal experiences to the gift donor communication interface as well as receive one or more selected reveal experiences from the gift donor communication interface and provide a gift redemption code based on the one or more selected matched gift options and the selected reveal experience to the gift donor communication interface.

Additionally, the computer server may have a redemption software engine stored in the one or more server storage devices and executed by one or more server processors. The redemption software engine may receive the gift redemption code from a gift recipient communication interface; and provide the selected reveal experience to the gift recipient communication interface based on the gift redemption code wherein the gift donor communication interface and the gift recipient communication interface are each one of the one or more server communication interfaces coupled to the communication network.

The systems, devices, and method s may also include a gift donor client device having one or more donor client communication interfaces coupled to the communication network, a donor user interface and one or more donor processors coupled to one or more donor storage devices. The gift donor client device may receive one or more gift recipient attributes and one or more gift experience attributes from a donor-server communication interface and display one or more gift recipient attributes and one or more gift experience attributes on the donor user interface. Further, the gift donor client device may receive one or more donor selected gift recipient attributes and one or more donor selected gift experience attributes from the donor user interface provide one or more donor selected gift recipient attributes and one or more donor selected gift experience attributes to the donor-server communication interface wherein the donor-server communication interface is one of the one or more donor client communication interfaces.

In addition, the systems, devices, and method s may also include a gift recipient client device having one or more recipient client communication interfaces coupled to the communication network, a recipient user interface and one or more recipient processors coupled to one or more recipient storage devices. The gift recipient client device may receive a gift redemption code from the recipient user interface and provide the gift redemption code to the recipient-server communication interface, further, the gift recipient client device may receive the selected reveal experience from the recipient-server communication interface based on the gift redemption code; and display the selected reveal experience on the recipient user interface.

Each of the one or more gift options may be stored in a database are assigned one or more gift recipient attributes and one or more gift experience attributes. Further, the computer server may receive donor selected gift recipient attributes and the donor selected gift experience attributes from the gift donor communication interface; and the matching software engine provides one or more matched gift options to the gift donor communication interface by comparing the donor selected gift recipient attributes and the donor selected gift experience attributes to the gift recipient attributes and gift experience attributes associated with each of the one or more gift options stored in the database.

In addition, the matching software engine may determine a first gift option as a first matched gift option by determining the number of donor selected gift recipient attributes and the donor selected gift experience attributes in common with the gift recipient attributes and gift experience attributes of the first gift option is at least equal to a matching threshold. Further, the matching software engine may determine a first gift option as a first matched gift option as a match by determining a percentage of donor selected gift recipient attributes and the donor selected gift experience attributes in common with the gift recipient attributes and gift experience attributes of the first option is at least equal to a percentage matching threshold.

Additionally, the gift donor client device may receive one or more matched gift options from the donor-server communication interface and display the one or more matched gift options on the donor user interface. Further, the gift donor client device may provide one or more selected matched gift options to the donor-server communication interface. Also, the gift donor client device may receive one or more reveal experiences from the donor-server communication interface and displays the one or more reveal experiences on the donor user interface as well as receive one or more one or more selected reveal experiences from the donor user interface and provide one or more selected reveal experiences to the donor-server communication interface. In addition, the gift donor client device may receive a gift redemption code based on the one or more selected matched gift options and the selected reveal experience from the donor-server communication interface; and display the gift redemption code on the donor user interface.

Further, selection software engine may select a default matched gift option and the reveal software engine may select a default reveal. In addition, the reveal software engine may receive a user generated reveal from the gift donor communication interface. Also, the matching software engine may provide one or more matched gift options based on the donor selected gift recipient attributes, the donor selected gift experience attributes, and user feedback to the gift donor communication interface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

FIG. 1 is an exemplary system for providing gift selection and gift redemption services in an e-commerce environment over a communication network;

FIGS. 2-11 are exemplary user interfaces, each of which may be used in an exemplary system for providing gift selection and gift redemption services in an e-commerce environment over a communication network;

FIG. 12 is a functional block diagram of an exemplary computer server or other computing device that may be used in an exemplary system for providing gift selection and gift redemption services in an e-commerce environment over a communication network;

FIG. 13 is a functional block diagram of an exemplary client computing device that may be used in an exemplary system for providing gift selection and gift redemption services in an e-commerce environment over a communication network;

FIGS. 14A-B are flow charts of exemplary methods for providing gift selection and gift redemption services in an e-commerce environment over a communication network;

FIGS. 15A-B are flow charts of exemplary methods for providing gift selection and gift redemption in an e-commerce environment over a communication network; and

FIG. 16 is a flow chart of an exemplary method for matching gift options with selected attributes to be used for providing gift selection and gift redemption services in an e-commerce environment over a communication network;

FIG. 17 is a flow chart of an exemplary method for providing gift selection and gift redemption in an e-commerce environment over a communication network.

### DETAILED DESCRIPTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

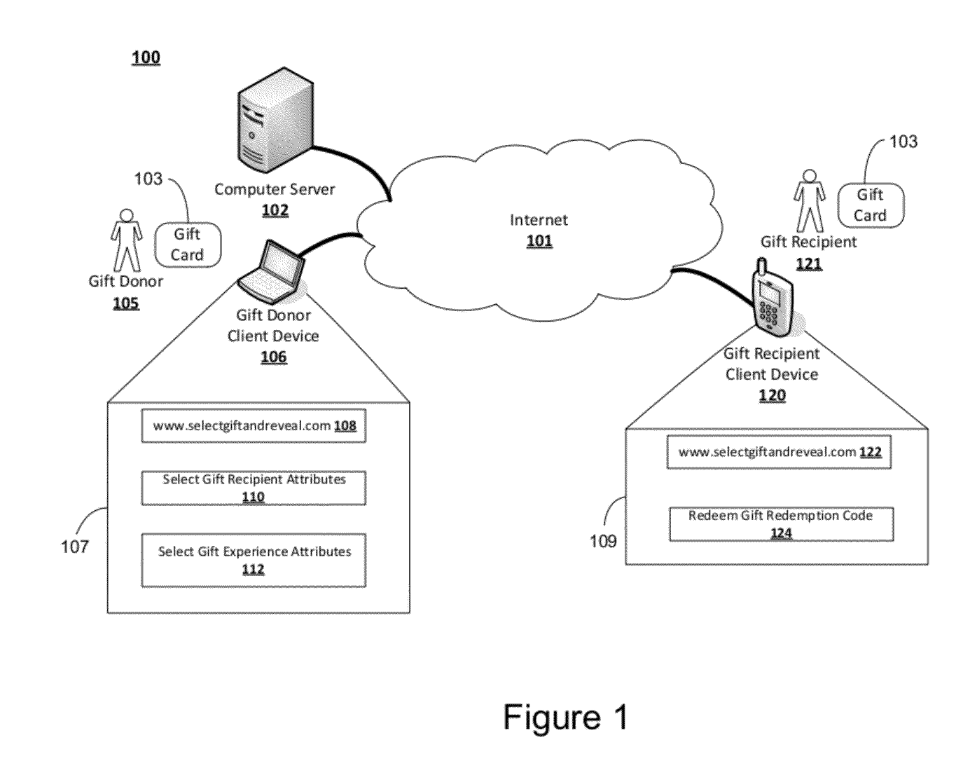

FIG. 1 is an exemplary system 100 for providing gift selection and gift redemption services in an e-commerce environment over a communication network 101 such as the Internet. The system 100 may include a computer server 102 coupled to one or more client devices (106 and 120) across the Internet 101 or some other communication network. The computer server may be any computing device capable of hosting an e-commerce website, server software application, mobile server application, or some other e-commerce server software application. The client devices (106 and 120) may be personal computers, laptop computers, notebook computers, smartphones or any other computing device having a user interface or other client software application capable of accessing a website or server software application (e.g. mobile) from the computer server 102. In such a system 100 for providing gift selection and gift redemption services in an e-commerce environment, there may be a gift donor client device 106 and a gift recipient client device 120 used by a gift donor 105 and a gift recipient 121, respectively.

An embodiment of the disclosure may have the computer server 102 host an e-commerce website and the client devices (106 and 120) accessing the website using one or more client software applications including a web browser user interface. A gift donor 105 may purchase a gift card having a gift code to present as a gift to another person. Further, the gift donor 105 may be a user of a client device 106 that may select a gift and gift reveal experience as well as receive a gift redemption code that may be printed on a gift card 103 from the e-commerce website hosted by the computer server 102. Also, the gift donor 105 may provide a gift redemption code/gift card 103 to a gift recipient 121 who may be a user of client device 120 that enters and redeems the gift redemption code and views the gift reveal experience from the e-commerce website hosted by the computer server 102. In addition, e-commerce website hosted by the computer server 102 provides functions that may used by or accessed from the gift donor client device 106 through the client device's (106) user interface. Such functions may include allowing a gift donor 105 to select a gift based on the attributes of the gift itself as well as attributes of the gift recipient 121, select a gift reveal experience and receive a gift redemption code to be given to a gift recipient 121. Alternative embodiments may incorporate information regarding the recipient from social media as well as web browsing preferences and e-commerce transactions online. Moreover, the e-commerce website hosted by the computer server 102 provides functions that may used by or accessed from a gift recipient client device 120 through the client device's (120) user interface. Such functions may include allowing a gift recipient 121 to enter and redeem a gift code and view a gift reveal experience as well as allowing the gift recipient 121 to share the reveal with friends and family.

The computer server 102 may host an e-commerce website that may include a web page (107 and 108) accessible by a gift donor client device 106 and allows a gift donor 105 to select a gift for a particular type of gift recipient 121 based on gift recipient attributes 110 and gift experience attributes 112. For such actions, the web page 107 may have a control button 110 to allow a gift donor 105 to select gift attributes and a control button 112 to select gift experience attributes. Gift recipient attributes describe the particular type of person as related to the gift recipient 121. The gift recipient attributes may include the types of relationship with the gift donor 105 (spouse, father, mother, etc.) or the type of activities related to the gift recipient's interests (sports, movies, books, outdoors, etc.). Alternatively, gift experience attributes may be attributes that indicate the feeling a gift recipient may enjoy in viewing the gift. Such attributes may include romantic, adventurous, holiday, etc.

As described in the present disclosure, the system 100 may provide the gift donor 105 a gift redemption code/gift card 103 based on a selected gift and selected gift reveal. Such a gift redemption code/gift card 103 may be given to the gift recipient 121 by the gift donor 105. Further, the gift recipient 121 may use a client device 120 to access a web page (109 and 122) from the e-commerce website hosted by the computer server 102 to redeem the gift redemption code/gift card 103 and to view the gift. Consequently, the client device 120 may access a web page 109 having a control button 124 to redeem the gift redemption. As described in the present disclosure, selecting the redeem gift redemption code allows the gift recipient to experience the gift reveal as well view the gift.

The embodiment described FIG. 1 discusses that the client devices (106 and 120) may have user interfaces (107 and 109) such as a web browser. However, persons of ordinary skill in the art would understand that the client devices (106 and 120) may be smartphones or other computing devices and that user interfaces (107 and 109) may be mobile applications or other types of client software applications implemented by a client device or user interface to access an e-commerce website, a mobile server software application, or other type of server software application hosted by the computer server 102.

A preferred embodiment may include a gift donor 105 acquiring or purchasing the gift card 103 having a gift redemption code from a retailer. In such an embodiment, the gift donor 105 may enter the gift redemption code into the website dialog box (not shown). After the computer server hosting the website verifies the gift redemption code, may select gift attributes and gift recipient attributes or have the hosting website access information pertaining to the gift recipient from different Internet sources such as social media (e.g. Facebook, Twitter, etc.), streaming video (e.g. Netflix, Hulu, YouTube, etc.) and e-commerce (e.g. Amazon, etc.) websites as described in the present disclosure.

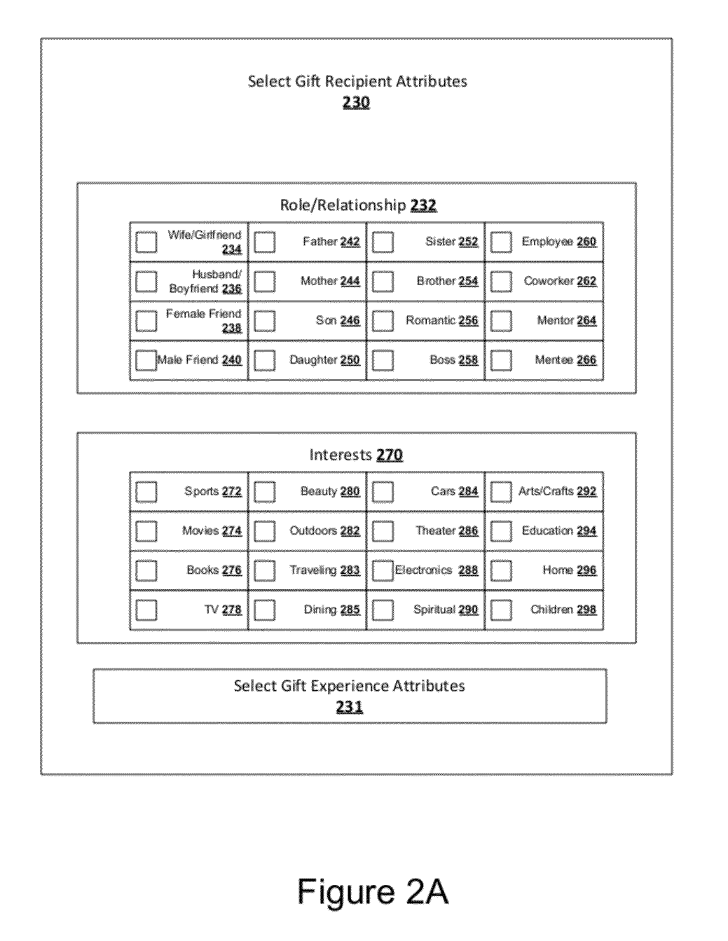

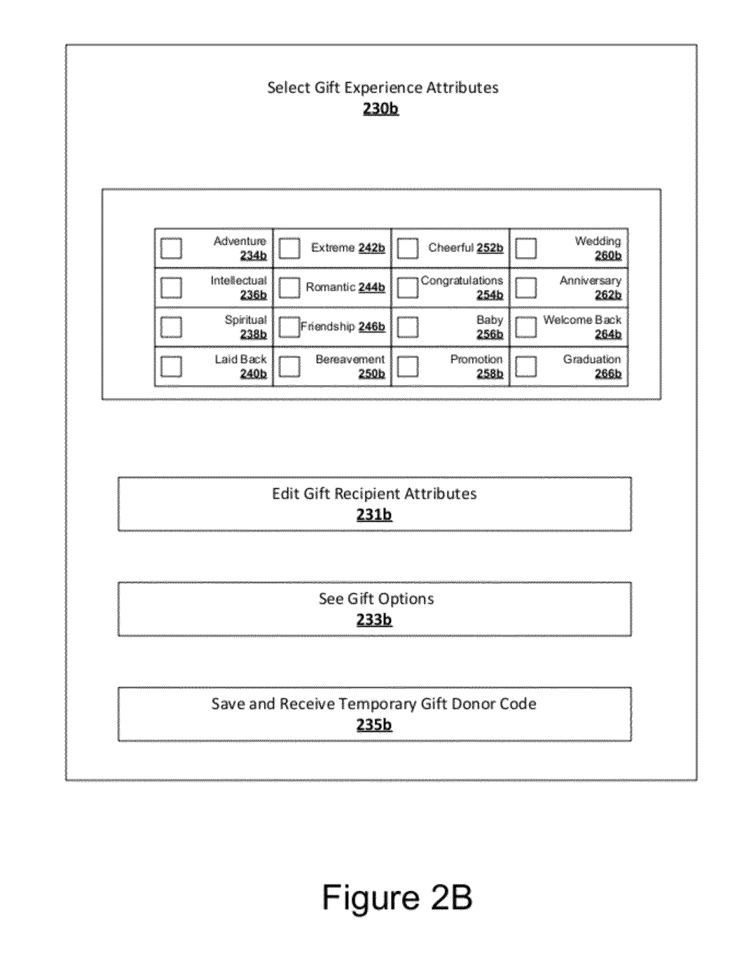

A gift donor 105 may select the control button 110 that allows for selection of one or more gift recipient attributes. Further, selection of control button 110 may cause the client device 106 to display gift recipient attribute web page on the user interface 107. FIG. 2A is an exemplary user interface that displays a web page 230 that allows a gift donor to select one or more gift recipient attributes. The web page 230 allows the gift donor to select one or more role/relationship attributes (232-266) based on the relationship of the gift donor to the gift recipient. For example, a gift recipient may be the wife of the gift donor. Thus, the gift donor may select wife/girlfriend attribute by selecting a check box 234. Further, the web page 230 allows the gift donor to select one or more interests attributes of the gift recipient (270-298). For example, the gift recipient may like fine dining and traveling. Thus, the gift donor may select the dining attribute and the traveling attribute by selecting check box 285 and check box 283, respectively. In addition, the gift donor may select a control button 231 to further select gift experience attributes. Persons of ordinary skill in the art would understand that the role/relationship attributes as well as the interests attributes are exemplary gift recipient attributes and that the type of gift recipient attributes (e.g. physical appearance, age, educational, professional, ethnic, and geographical background, etc.) may be additional gift recipient attributes.

Alternative embodiments may implement additional methods to determine gift recipient attributes that include, but are not limited to, social media sources and tracking online preferences, web browsing, online purchases, etc. Further, more than one donor may be able to select gift recipient and gift experience attributes. For example, a social media group may be generated and interface with the gift selection software platform residing and running on the computer server 102. In addition, the multiple donors may be able to vote on the most significant gift recipient or gift experience attributes through such an interface. Other embodiments may include a gift donor choosing not to select any gift recipient attributes or gift experience attributes. Instead, the gift recipient may select his/her own gift recipient attributes and gift experience attributes. Alternatively, the gift donor may not have the gift recipient select the different attribute and have gift recipient use the gift card in a traditional manner to purchase products or services in a conventional brick and mortar store.

Selection of control button 231 may cause a client device to display gift experience attribute web page 230b on a client device user interface. FIG. 2B is an exemplary user interface that displays a web page 230b that allows a gift donor to select one or more gift experience attributes (234b-266b). For example, the gift recipient may be the wife of the gift donor. In addition, the gift recipient may be interested in dining and traveling. Consequently, the gift donor may want not only the gift recipient experience a romantic feeling when discovering a gift given by the gift donor but also experience a sense of adventure. Thus, the gift donor may select the romantic attribute and the adventure attribute by selecting check box 244b and check box 234b, respectively. Further, the gift donor may select control button 231 b to review and edit the gift recipient attributes that may display a web page 230 on the client device user interface as shown in FIG. 2A. Alternatively, the gift donor may select control button 233b to have the client device user interface display a web page listing the gift options based on the gift donor's selected gift recipient attributes and gift experience attributes.

In addition, the gift donor may save the information entered or edited during the gift attribute and gift recipient attribute selection process (e.g. as shown in FIGS. 2A and 2B as well as in other embodiments known to those of ordinary skill in the art) by selecting control button 235b. Such a control button 235b may be on any web page that facilitates the gift selection process (e.g. selection of gift attributes, selection of gift recipient attributes, selection of gift option, etc.) Further, after selecting control button 235b, the computer server may provide the gift donor with a temporary gift donor code that may be displayed on a client device user interface. Such a temporary gift donor code may be used by the gift donor when returning to the e-commerce website to continue the gift selection process for the gift recipient. In addition, after selecting control button 235b, a web page may provide an email or other messaging function to the gift donor to send the temporary gift donor code to one or more other potential gift donors. Any of the potential gift donors may then access the e-commerce website to select additional attributes of the gift or gift recipient as well as the gift option. Hence, the e-commerce website facilitates more than one donor to be involved in the attribute selection (e.g. gift or gift recipient) gift reveal, gift option, or any other aspect of the gift selection process.

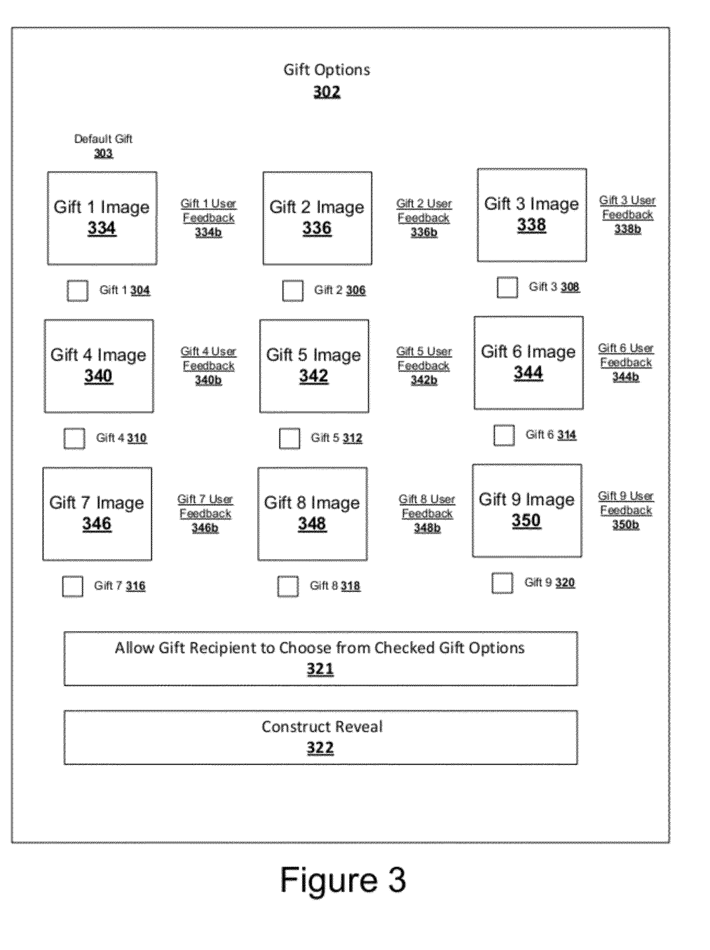

FIG. 3 is an exemplary user interface that displays a web page 302 on a client device that lists and allows a gift donor to select one or more gifts from one or more gift options. Each gift option is displayed with a gift image (334-350) that provides a visual description of the gift option. Clicking on one of the gift images (334-350) may display a text description of the gift option. A gift donor may select one or more gift options as a gift for the gift recipient by selecting a check box (304-320) associated with the gift option. Each gift option (334-350) may one of several types such as a product, a service, event, or philanthropic event. A product may be a tangible object that may be shipped to the gift recipient such as a DVD, a cell phone, computer, clothing, etc. Alternatively, a product may be in electronic form that may be downloaded by a gift recipient such as music, streaming video, software, etc. Further, examples of a service may include, but not limited to, spa services, vacation trips, restaurant dining, etc. An event may be concert tickets, theater tickets, sporting event tickets, etc. Philanthropic events may include donations to charity or non-profit organizations, tutoring schoolchildren, volunteering for charity or nonprofit organizations, etc. Further, the gift donor may select a control button 322 to construct or select a reveal for the gift that may be experienced by the gift recipient.

Alternative embodiments may include, but are not limited to, allowing a gift recipient to choose a subset of gift options chosen by a gift donor from the listed gift options 302 shown in FIG. 3. An exemplary implementation of such an aspect of the embodiment may be allowing a gift donor to check the one or more gift options by clicking the check box associated with each gift option (304-320). Further, clicking a control button 321 transmits information to a computer server from the client computing device that associates the checked gift options to the gift code that may eventually be given to the gift donor and presented to a gift recipient. Further, as discussed in the present disclosure, the gift recipient, upon and/or after experiencing a gift reveal, may be provided the list of the subset of gift options checked by the gift donor so that the gift recipient may choose one gift option to receive from the subset of gift options. Alternatively, the gift recipient may have an ability to choose a gift option instead of, or alternatively to, having the gift donor select the gift option. Such a selection process may include the gift recipient selecting attributes of the gift and gift recipient as shown in FIGS. 2A and 2B, for example. Further, the gift recipient may use keywords to choose a gift from an inventory of gifts to determine whether a particular gift is available for selection. Such functionality as a keyword search may be available to the gift donor as well. In addition, if the gift donor would not like to choose a gift option, the computer server may designate a gift option as a default gift option 303 that may be determined the most compatible by a matching algorithm to the gift recipient based on the gift experience attributes and the gift recipient attributes as well as from online sources (e.g. social media, streaming media, e-commerce, etc.), for example. A gift donor may select the gift option 304 designated as the default gift option to associate such a gift 304 to the gift redemption code that will be available to the gift donor after the gift selection process.

Further embodiments may include a gift donor purchasing a gift card worth $100 from a retailer. Subsequently, the gift donor interacts with a computer server using a web browser on the gift donor client device. The client application allows the gift donor (or in some embodiments the gift recipient) to select and purchase one or more gift options and charge the purchases to the gift card. In addition, if there is left over credit on a gift card after selecting several purchases, then the gift donor/gift recipient may have the option of donating the left over credit on the gift card to a donor selected charitable cause.

Additional embodiments may include a pre-purchase embodiment and a post-purchase embodiment. In the pre-purchase embodiment, the donor pays for the card first (e.g. by buying a physical gift card at a store and later customizing it online). In the post-purchase embodiment, the gift donor uses the features of a gift selection and gift redemption e-commerce website to generate and review a list of gift options suitable for the gift recipient. If the gift donor approves any f the gift options, then the gift donor may then purchase a gift card which can be a physical gift card mailed to the gift donor/gift recipient or a virtual gift card that can be downloaded, email, or otherwise electronically transferred across the Internet to the gift donor/gift recipient.

In addition, there may be links associated with each gift option that allows a gift selector (gift donor or gift recipient) to review user feedback for each gift option (334b-350b). Upon receiving a gift from the website, a gift recipient may be provided with an electronic form to provide feedback on the gift (e.g. product, service, event, or philanthropic event). The user feedback may be presented as text authored by past gift recipients and/or a rating from a scale of 1 to 5. Alternative embodiments may incorporate the rating from the user feedback associated with each gift option into the gift matching process in addition to the gift experience attribute and gift recipient attributes.

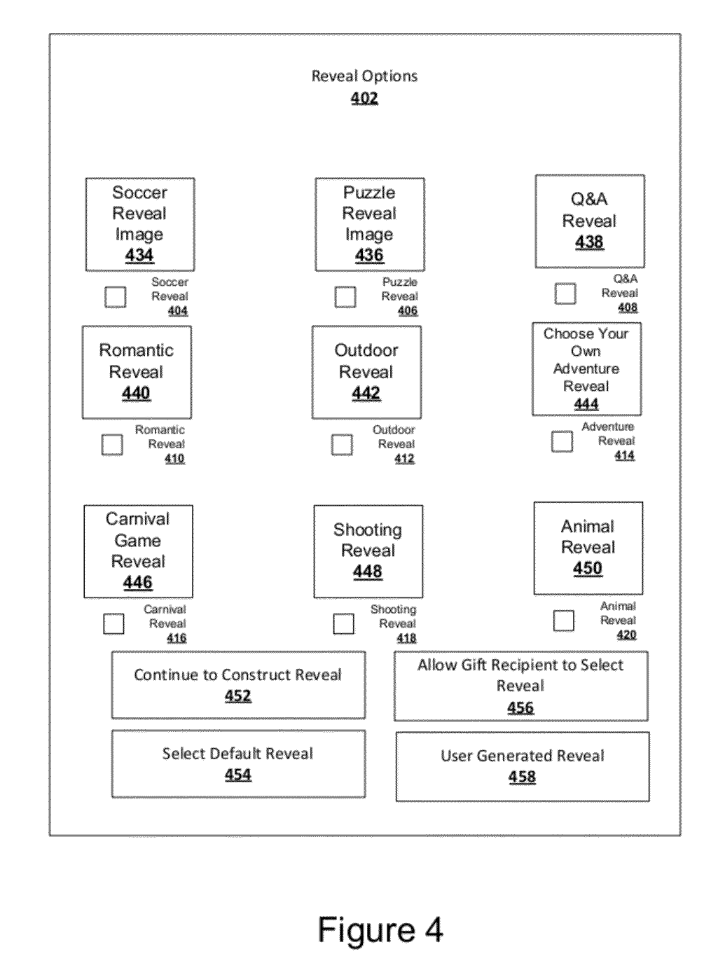

FIG. 4 is an exemplary user interface that displays a web page 402 on a client device that lists and allows a gift donor to select one or more gift reveal options. Each gift reveal option may be a specific template or have a series of animated actions or video of a particular theme and is displayed with a reveal image (434-450) that provides a visual description of the reveal option. Clicking on one of the reveal images (434-450) may display a text description of the reveal option as well as an animated series of actions or video describing the reveal. For example, a reveal with a traveling theme may have a series of animated actions or a video showing a plane taking off an airport runway. A gift donor may select one or more reveal options to be experienced by the gift recipient by selecting a check box (404-420) associated with the gift reveal option. For example, a gift donor may select a puzzle reveal 406, a question and answer (Q&A) reveal 438, and a romantic reveal 440 by selecting the respective check boxes (436, 438, and 440). After making one or more reveal option selections, a gift donor may select control button 452 access a next web page and to continue to construct the gift reveal.

Alternative embodiments may include a control button 454 that allows a gift donor (or a gift recipient in other embodiments) to select a default reveal. The default reveal may be selected by the computer server managing the gift selection process for the gift donor based on the gift attributes, gift recipient attributes, online information of the gift recipient (e.g. social media, streaming media, e-commerce activity, etc.), or popularity of a reveal by other users of the gift selection process. Further alternative embodiments may include a gift recipient to select a reveal. That is, a gift redemption code is generated based on a gift donor traversing the gift selection process as illustrated in FIGS. 2A, 2B, and 3, for example, but no reveal is selected by the gift donor. Instead, for example, a gift recipient is given the gift redemption code, enters the gift redemption code into the website managing a gift redemption process. Further, the gift redemption process may allow the gift recipient to construct a reveal.

Another alternative embodiment may allow a gift donor or a gift recipient to generate a reveal based on the user (e.g. gift donor or gift recipient) material by selecting a control button 458. For example, after selecting the control button 458, a web page may allow the user to upload a video or image as well as provide other software tools to incorporate upload content into a custom reveal. Such software tools are known to those of ordinary skill in the art.

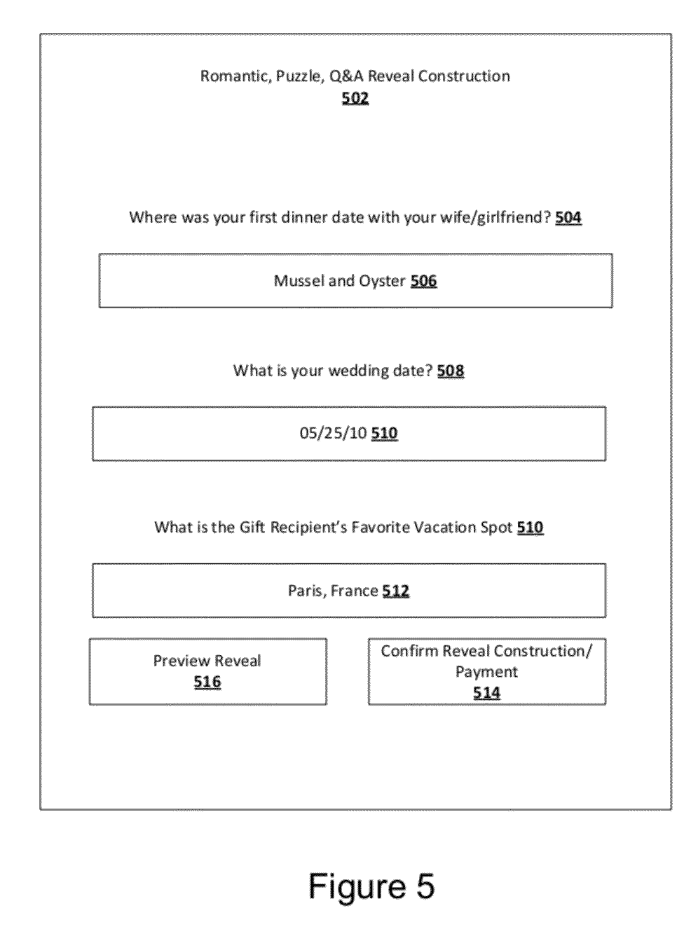

FIG. 5 is an exemplary user interface that displays a web page 502 to assist in constructing a romantic, puzzle, and Q&A reveal. The web page 502 may ask several questions to incorporate into the gift reveal. For example, the web page 502 may list the question “Where was your first dinner date with your wife/girlfriend?” 504. The gift donor may enter an answer “Mussel and Oyster” as a name of a restaurant in a dialog box 506. Further, the web page 502 may list the question “What is your wedding date?” 508. The gift donor may enter an answer “05/25/10” as the numerical representation of a date May 25, 2010 in a dialog box 510. In addition, the web page 502 may list the question “What is the Gift Recipient's favorite vacation spot?” 510. The gift donor may enter an answer “Paris, France” in a dialog box 512. After answering all the questions on the web page, the gift donor may preview the reveal by selecting control button 516. Alternatively, when the gift donor has completed constructing the reveal, a control button 514 may be selected that confirms the reveal construction and payment for the gift. Alternative embodiments may provide a gift donor an option to not construct a reveal and/or choose a default reveal.

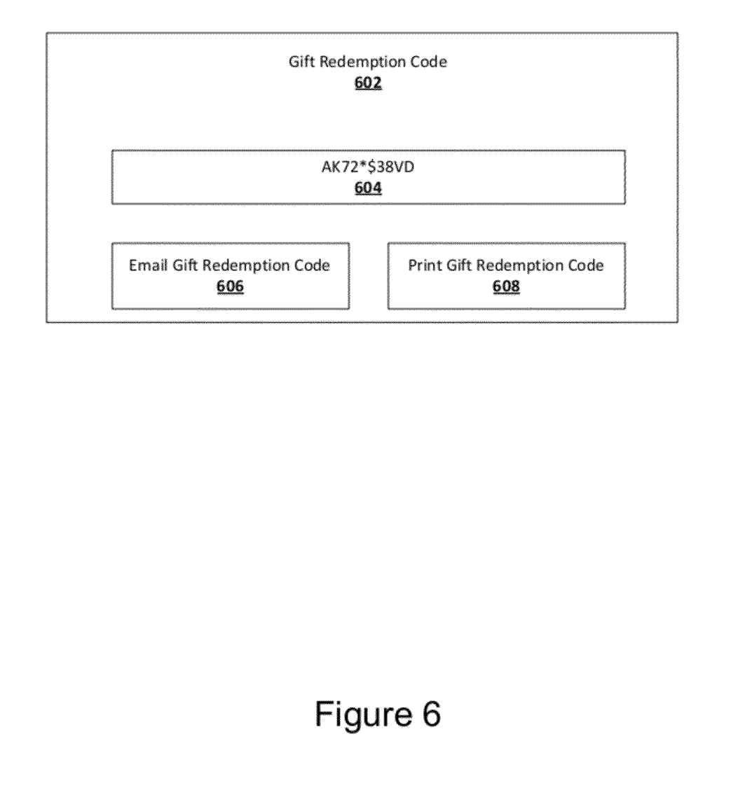

After confirming the construction of a reveal and providing payment through e-commerce methods known in the art (e.g. entering credit card information to a web page and the website operator verifying credit card information for payment with a merchant services provider), a website may provide a gift redemption code on a web page. FIG. 6 is an exemplary user interface that displays a web page 602 that lists a gift redemption code 604. The gift redemption code may not only be an alphanumeric code but also can be some other textual or graphical code (e.g. bar code, image, etc.). Alternative embodiments may allow the gift donor to email the gift redemption code to a gift recipient by selecting a control button 606. Further, the gift donor may be allowed to print the gift redemption code using a control button 608. The gift redemption code may be printed on a gift card or some other tangible medium. Alternative embodiments may allow a gift redemption code be placed on a gift card and the gift card may be delivered to a gift recipient by postal mail or electronically (i.e. the gift card is in electronic form). Software applications running on a computer server hosting a website providing the web page 602 associate the gift redemption code 604 with a gift selected by the gift donor as well as the gift reveal constructed by the gift donor.

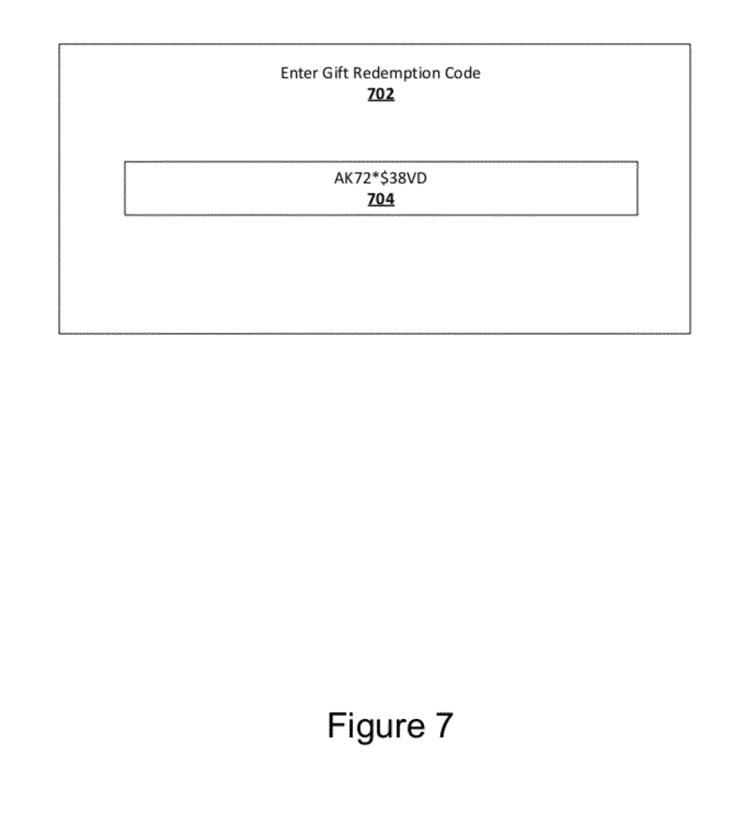

FIG. 7 is an exemplary user interface on a gift recipients client device that displays a web page 702 that allows a gift recipient to enter a gift redemption code in a dialog box 704. Thereafter, a computer server that hosts and operates an e-commerce website that provides the web page 702 receives the gift redemption code entered by the gift recipient into the client device.

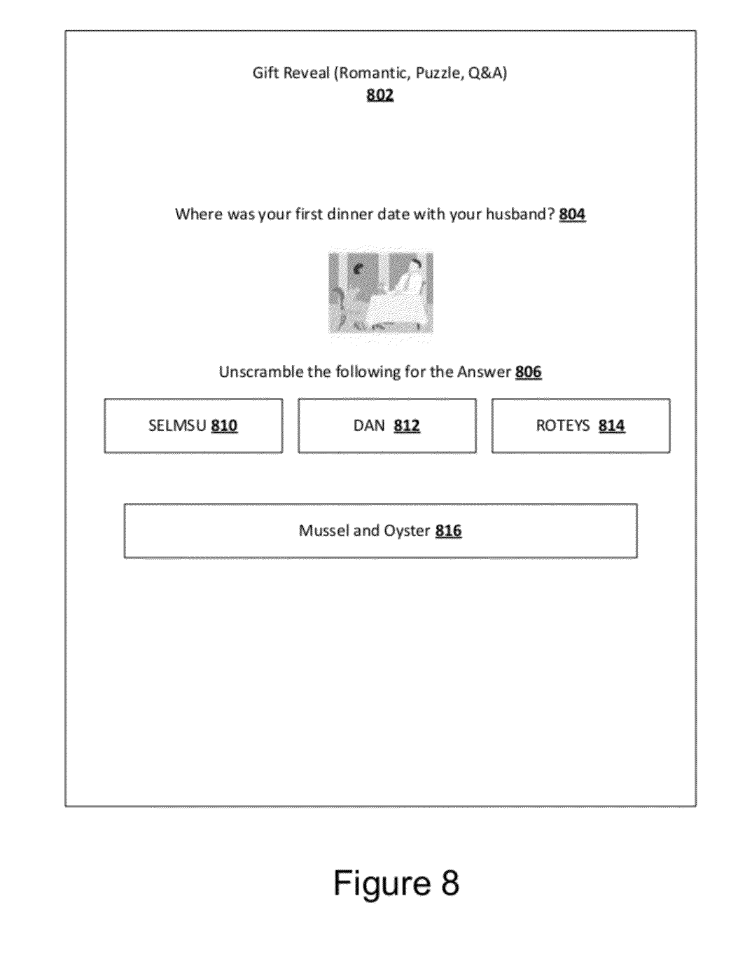

FIG. 8 is an exemplary user interface on a gift recipients client device that displays a web page 802 that is an initial web page for the gift reveal experience. Moreover, the gift reveal may have been constructed by the gift donor when selecting the gift. Alternatively, the gift reveal experience may be a default or automated gift reveal experience generated by the computer server hosting the e-commerce website. Such a default or automated gift reveal experience may be based on the gift recipient attributes and gift experience attributes selected by the gift donor at the time of gift selection or on the popularity of the reveal by other website users.

Referring to FIG. 8, web page 802 displays an initial page for a gift reveal constructed using romantic, puzzle, and question & answer (Q&A) reveal templates or themes. For example, the gift reveal experience web page 802 may ask the gift recipient “Where was your first dinner date with your husband?” 804. Further, the web page 802 may provide a hint to the answer, such as the name of a restaurant, in a puzzle format (806, 810, 812, and 814). The words that make up the name of the restaurant may be scrambled (810-814). The gift recipient may enter the unscrambled name of the restaurant into a dialog box 816 on the web page 802 displayed on the client device user interface. After receiving restaurant name information entered in the dialog box 816 from the client device, the website may instruct the client device to display a next web page to continue the gift reveal experience for the gift recipient.

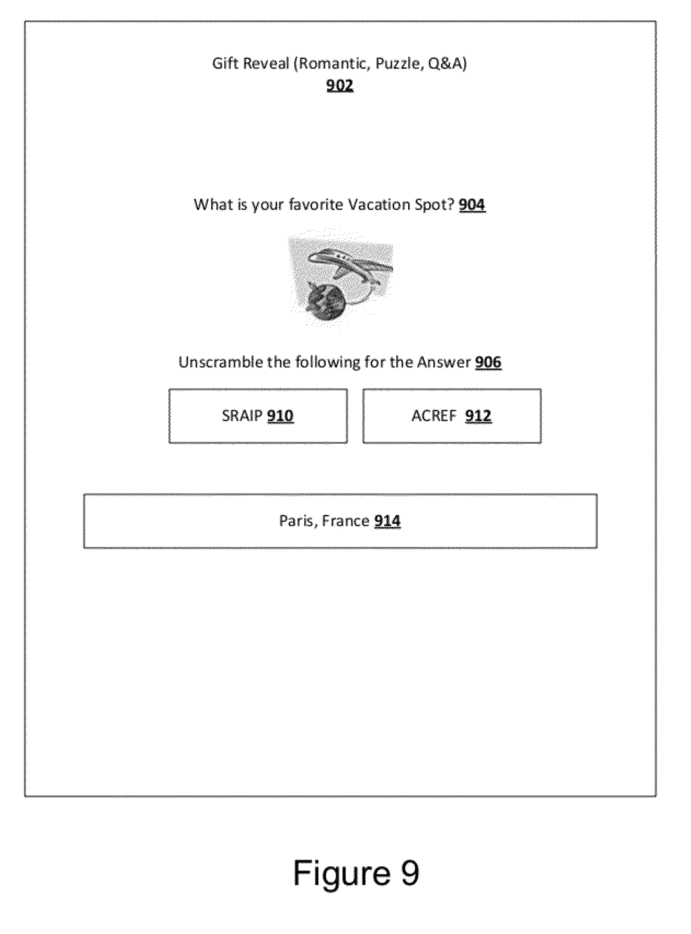

FIG. 9 is an exemplary user interface on a gift recipients client device that displays a next web page 902 for the gift reveal experience. The type of reveal may be, for example as shown in FIG. 8, a combination of romantic, puzzle and Q&A 902. Further, the web page may list a question “What is your favorite vacation spot? 904. The reveal may also include a series of animated actions or video of a plane taking off an airport runway (that may or may not include a soundtrack), for example. Further, the web page 902 may provide a hint to the answer, such as the name of the city and country, in a puzzle format (906, 910, and 912). The words that make up the name of the city and country may be scrambled (910 and 912). The gift recipient may enter the unscrambled name of the vacation spot (city and country) into a dialog box 914 on the web page 902 displayed on the client device. After receiving name of the vacation spot information entered in the dialog box 914 from the client device, the website may instruct the client device to display a next web page to continue the gift reveal experience to the gift recipient.

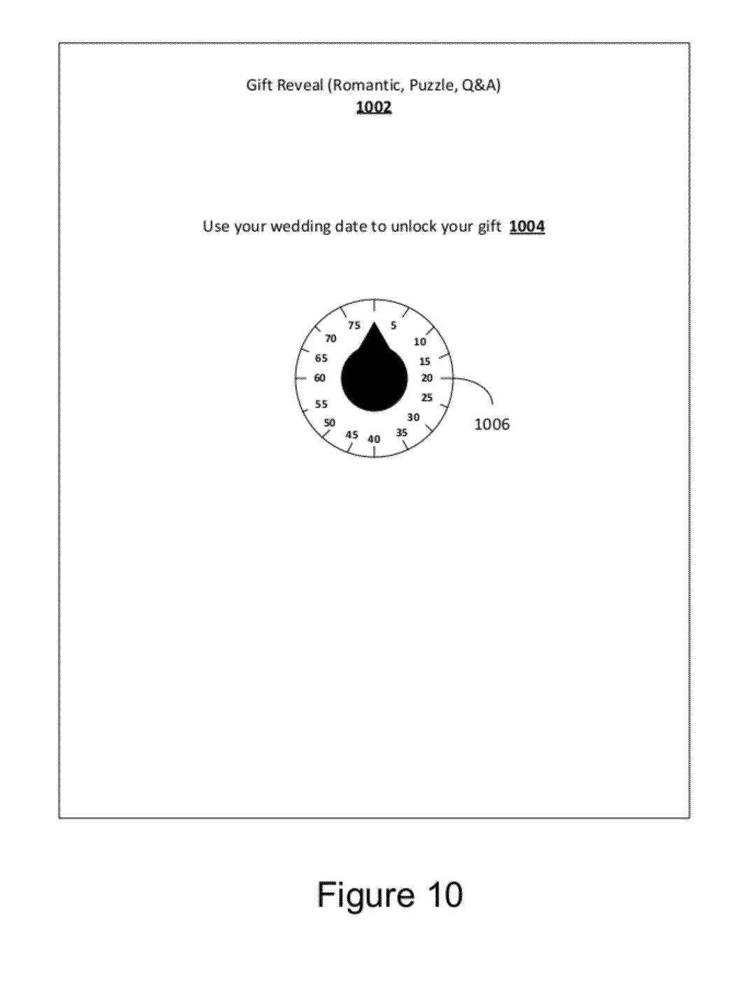

FIG. 10 is an exemplary user interface on a gift recipient's client device that displays a next web page 1002 for the gift reveal experience. The type of reveal may be, for example as shown in FIGS. 8 and 9, a combination of romantic, puzzle and Q&A 1002. Further, the web page may provide a game such as unlocking a combination lock on the web page 1006 using a numerical representation of the gift recipient's wedding date 1004. After receiving combination information entered by scrolling the combination lock 1006 from the client device, the website may instruct the client device to display a next web page to continue the gift reveal experience to the gift recipient. Persons of ordinary skill in the art would understand that multiple donors may contribute to the selection of the reveal. Thus, alternative embodiments may include an answer to one or more puzzle pieces in a puzzle reveal to be related to one of the multiple gift donors.

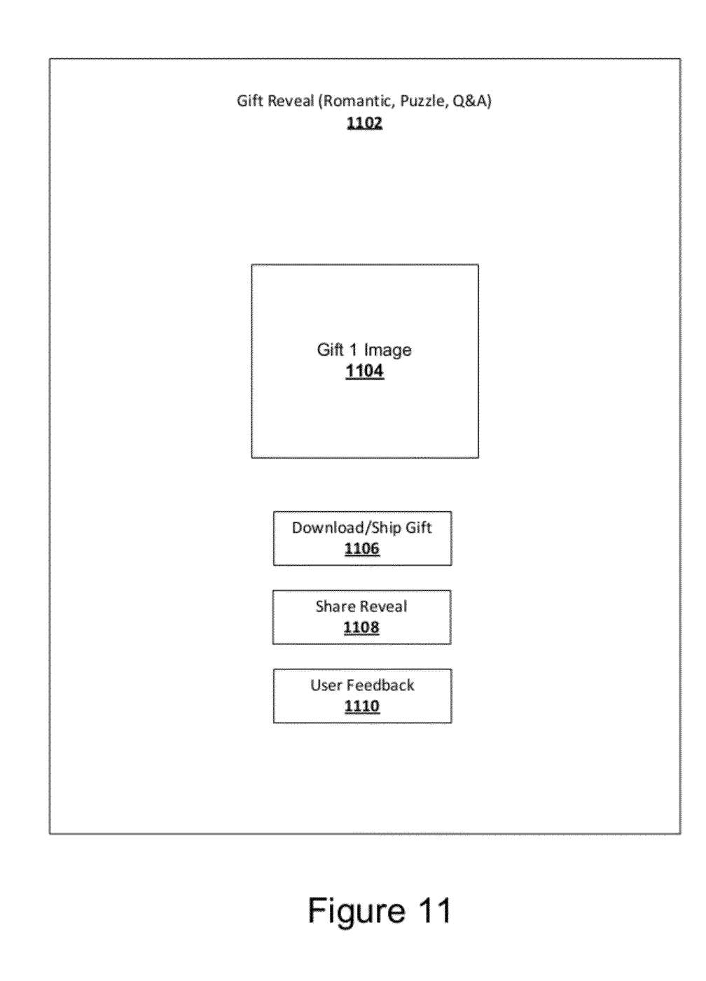

FIG. 11 is an exemplary user interface on a gift recipient's client device that displays a next web page 1102 for the gift reveal experience. For example, after answering questions listed in web pages shown in FIGS. 8 and 9 then playing the combination lock game shown in FIG. 10, a computer server hosting and providing the gift reveal experience to the gift recipient may provide a web page 1102 to be displayed on a gift recipient's client device that shows the gift as a gift image 1104. The web page 1102 may also include a control button 1106 that allows the gift recipient to either download the gift or gift image to the client device or ship the gift (1104) to the gift recipient's residence, depending on the type of gift. For example, the gift 1104 may be a trip to the French Riviera and the gift recipient may want to download (or email) the travel itinerary to the client device. Alternatively, the gift may be an item such as a fondue pot that may be shipped to the gift recipient's residence. To such an extent, selecting control button 1106 may facilitate download or shipment of gift.

Further, a control button 1108 may allow a gift recipient to share the reveal experienced by the gift recipient. The gift recipient may be able to share the reveal using one or methods such as email, social media website, mobile texting, messaging, mobile messaging, video, etc. In addition, a control button 1110 may be selected to allow the gift recipient to provide user feedback in the future. For example, selecting control button 1110 may provide an electronic form to a user to enter a user's email address. Some time in the future, the computer server managing the website administering the gift redemption process may email a user feedback electronic form such that the gift recipient may enter user feedback regarding the gift.

Alternative embodiments may have a web page 1102 include a list of gift options from which the gift recipient may select one or more gifts. Moreover, the web page may provide a keyword search dialog box to allow the gift recipient to search a gift inventory for a particular set of gifts.

As described in the present disclosure, the gift reveal may provide a gift recipient with a multimedia experience when presented a gift through a gift redemption process in an e-commerce environment over a communication network. Such a reveal experience may be selected by a gift donor and/or based on gift, gift experience, and gift experience attributes as well as the popularity of one or more gift reveals. Further a matching software application may be used to provide potential gift options suited to the gift recipient based on gift, gift experience, and gift experience attributes as well as online information and the popularity of one or more gifts.

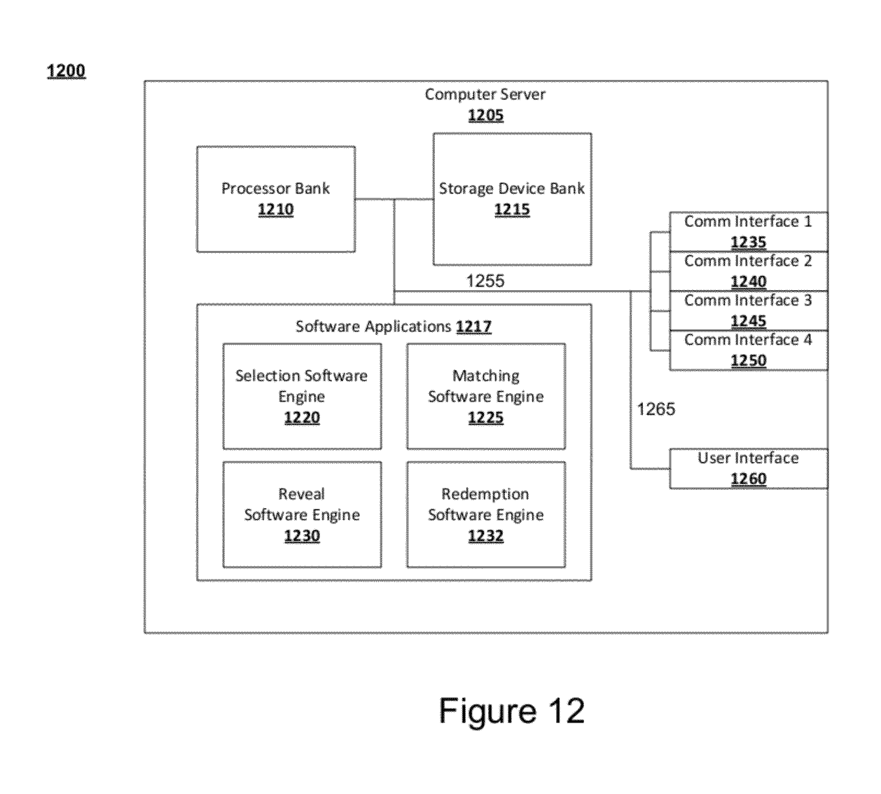

FIG. 12 is a functional block diagram 1200 of an exemplary computer server or other computing device 1205 that may be used in an exemplary system for providing gift selection and gift redemption services in an e-commerce environment over a communication network. The computer server 1205 may include several different components such as a processor bank 1210, storage device bank 1215, one or more software applications 1217, and one or more communication interfaces (1235-1260) that may also include a user interface 1260. The processor bank 1210 may include one or more processors that may be co-located with each other or may be located in different parts of the computer server 1205. The storage device bank 1215 may include one or more storage devices. Types of storage devices may include memory devices, electronic memory, optical memory, and removable storage media. The one or more software applications 1217 may include a software selection engine 1220, a matching software engine 1225, a reveal software engine 1230, and a redemption engine 1232. Further, the computer server 1205 may include other software applications (not shown). Such software applications may include control software application that may implement software functions that facilitate the functions of the computer server 1205 such as web hosting and providing data to the communication interfaces (1235-1260).

The selection software engine 1220 may be used in the gift selection and gift redemption services in an e-commerce environment. As discussed in the present disclosure, a computer server 1205 may provide web pages of a website or software applications to a client device such as a computer or mobile telephone. The web pages or software applications may allow a user of the client device to select a gift for a gift recipient by a gift donor. Further, the web pages or software applications provide the gift donor to enter the gift recipient attributes as well as gift experience attributes and then offer gift selections based on the gift recipient attributes and gift experience attributes. Gift recipient attributes may include, but not limited to, the relationship of the gift recipient to the gift donor. Additional gift recipient attributes may include the gift recipient's interests (e.g. sports, movies, dining, traveling, outdoors, etc.). Moreover, gift experience attributes may be feelings the gift donor may want to elicit when a gift revealed to the gift recipient. Gift experience attributes may include, but are not limited to, such attributes as romantic, adventure, relaxing, spiritual, etc. The listing and type of gift recipient attributes and gift experience attributes (collectively may be called the gift attributes) are controlled and managed by the selection software engine 1220. The gift attributes are provided to a client device across one of the communication interfaces (1235-1250) to be displayed on an application (e.g. web browser) on the client device. Further, such an application allows the user of a client device to select one or more gift attributes. After gift recipient attributes and gift experience attributes are selected by the gift donor into a web page or software application on the client device, the client device provides the gift recipient attributes and gift experience attributes to the computer server 1205. The selection software engine 1220 may receive and process the gift donor's selected gift recipient attributes and gift experience attributes to gather and provide a list of gift options based on the gift attributes.

Aspects of the present disclosure may include gift selection and gift redemption services having a database of gift options stored in the storage device bank 1215 on the computer server 1205. One or more gift recipient attributes and one or more gift experience attributes may be associated with each gift option in the database by an administrator of the database. Such an administrator of the database may be a person manually associating gift attributes to each gift option stored in the database, or alternatively, may be a software application that associates gift attributes with gift options stored in the database based by searching a text description of the gift option for keywords associated with a gift attribute. After receiving the gift recipient attributes and the gift experience attributes from the gift donor client device (through one of the communication interfaces 1235-1250), the selection software engine may relay the gift recipient attributes and the gift experience attributes to the matching software engine 1225. Further, the matching software engine 1225 may compare the selected gift recipient attributes and the gift experience attributes to the gift recipient attributes and the gift experience attributes of each gift option in the database of gift options. The matching software engine may be programmed manually or in an automated manner with a matching threshold. Consequently, if a gift option has a number of gift recipient attributes and the gift experience attributes matching a subset of the gift recipient attributes and the gift experience attributes selected by the gift donor and that the number is more than or equal to the matching threshold, then the matching software engine designates the specific gift option as a match.

For example, a gift donor may choose gift recipient attributes such as wife, dining, and traveling, and gift experience attributes such as romantic and adventure. After receiving such attributes, the matching software engine 1225 may compare these attributes with the attributes of each gift option in the gift option database stored in the storage device bank 1215. Further, the matching threshold programmed in the matching software engine 1225 may be a matching threshold value equal to 2. That is, when at least two attributes of a gift option match the attributes selected by the gift donor, then the gift option is designated as a match. Persons of ordinary skill in the art would understand that the matching threshold may not be an absolute number but may be obtained using matching algorithms known in the art. As an example, the matching threshold may be a percentage (40%) of the number of attributes selected by the gift donor. Consequently, in the previous example where there are five selected gift attributes selected are wife, dining, traveling, romantic and adventure, the matching software engine may designate a gift option as a match when at least two gift attributes associated with a gift option in the associated database match the selected gift attributes. After comparing the attributes selected by the gift donor to attributes of each gift option in a section, subset or portion of the database of gift options and designating a number of gift options as matches, the matching software engine 1225 sends information of all or a subset of the gift option matches to the selection software engine 1220. Thereafter, the selection software engine 1220 may facilitate a listing of the gift option matches (or images and descriptions thereof) on a web page or software application provided to the gift donor client device through the one or more communication interfaces (1235-1250).

A gift donor may then select a gift option listed in a web page or software application presented on the client device display. The computer server 1205 may receive the selected gift option and store the selection information in the storage device bank 1215. Aspects of the present disclosure may include a gift selection and gift redemption process having a gift reveal experience to be constructed or selected by the gift donor. The reveal software engine 1230 assists the computer server 1205 to present different aspects of a gift reveal construction process to the gift donor client device. The reveal software engine 1230 may facilitate a listing of the reveal options (e.g. templates or themes) on a web page or software application provided to the gift donor client device through the one or more communication interfaces (1235-1250). Further, the gift donor may select one or more gift reveal options (e.g. templates or themes) on the displayed web page or software application. The computer server 1205 receives the selected gift reveal information and relays the gift reveal information to the reveal software engine 1230. In addition, the selection software engine 1220 may receive the gift reveal information, either from the reveal software engine 1230, or from another aspect of the computer server 1205, and associate the selected gift option with the selected gift reveal. Further, the gift donor may include or generate a custom or semi-custom reveal by uploading photographs and video.

The redemption software engine 1232 may generate a gift redemption code and associate the gift redemption code with the selected gift option as well as the selected gift reveal. Alternatively, the redemption software engine may generate and send a gift redemption code to the selection software engine that may associate the selected gift option and the select gift reveal with the gift redemption code. In addition, the redemption software engine 1232 may facilitate a listing of the gift redemption code on a web page or software application provided to the gift donor client device through the one or more communication interfaces (1235-1250). Further, the gift redemption code may be stored in a look-up table or gift redemption code database associating the gift redemption code with the gift and gift reveal selected by the gift donor. The look-up table may be stored in the storage device bank 1215. Persons of ordinary skill in the art would understand that other methods, systems, and devices may be used to store and associate the gift redemption code with the gift and gift reveal selected by the gift donor.

Moreover, a gift recipient may be given the gift redemption code by the gift donor. Further, the gift recipient may access gift selection and gift redemption services, aspects of which are described in the present disclosure, through an e-commerce website or other server software application hosted or provided by the computer server 1205. The gift recipient may access such an e-commerce website or other software application using a client device and associated user interface. The computer server 1205 may provide a web page or other software application to the client device to display on the user interface that may allow a gift recipient to enter a gift redemption code. The client device may transmit such a gift redemption code to the computer server 1205 over a communication network. Upon receiving the gift redemption code through a communication interface (1235-1250), the computer server 1205 may relay the gift redemption code to the redemption software engine 1232. Further, the redemption software engine 1232 may process the gift redemption code to determine the gift and gift reveal associated with the gift redemption code. Processing may be performed by methods, systems, and devices known to those of ordinary skill in the art. Such an embodiment may be the redemption software engine 1232 accesses a look-up table or gift redemption database from the storage device bank 1215 and search the look-up table or gift redemption database for the gift redemption code. The look-up table or database may also store the gift option and gift reveal associated with the gift redemption code. Additionally, the redemption software engine 1232 may relay the gift option and gift reveal associated with the gift redemption code to the reveal software engine 1230.

Upon receiving the gift option and gift reveal associated with the gift redemption code, the reveal software engine processes the gift reveal and may facilitate providing the gift reveal on one or more web pages (or using a software application) provided to the gift recipient client device through the one or more communication interfaces (1235-1250). The gift recipient client device would display the one or more web pages to the client device user interface for the gift recipient to experience the gift reveal. Upon completion of the reveal, the reveal engine may facilitate a listing of the gift option on a web page or software application provided to the gift recipient client device through the one or more communication interfaces (1235-1250) and allows the gift recipient to view the gift or gift option. Further the web page may allow the gift recipient to download the gift or gift option to the client device or ship the gift to the gift recipient's residence.

Person of ordinary skill in the art would understand that the software functions described as separate software engine (1220-1232) may be combined or separated into one or more software engines or software applications. Further, persons of ordinary skill in the art would understand that components shown in the FIG. 12 such as the processor bank 1210, storage device bank 1215, and software applications 1217, may be located across several different computer servers or devices. For example, the one or more storage devices may be located in a database server coupled to a computer server. In addition, the storage devices may contain a database that stores one or more gift options each of which may be associated with one or more gift recipient attributes and gift experience attributes.

Each of the communication interfaces (1235-1250) shown in FIG. 12 may be software or hardware associated in communicating to other devices or to a computer server user. The communication interfaces (1235-1250) may be of different types that include a user interface, USB, Ethernet, WiFi, WiMax, wireless, optical, cellular, or any other communication interfaces coupled to a communication network. One of the communication interfaces (1235-1250) may be a communication interface which may be coupled to a client device over a communication network. Further, user interface 1260 may be an input/output device such as a keyboard with display, touchscreen or other some other type of user interface known to those of ordinary skill in the art.

Intra-device communication links (1255 and 1265) between the processor bank 1210, storage device bank 1215, software applications 1217, communication interfaces (1235-1250), and user interface 1265 may be one of several types that include a bus or other communication mechanism.

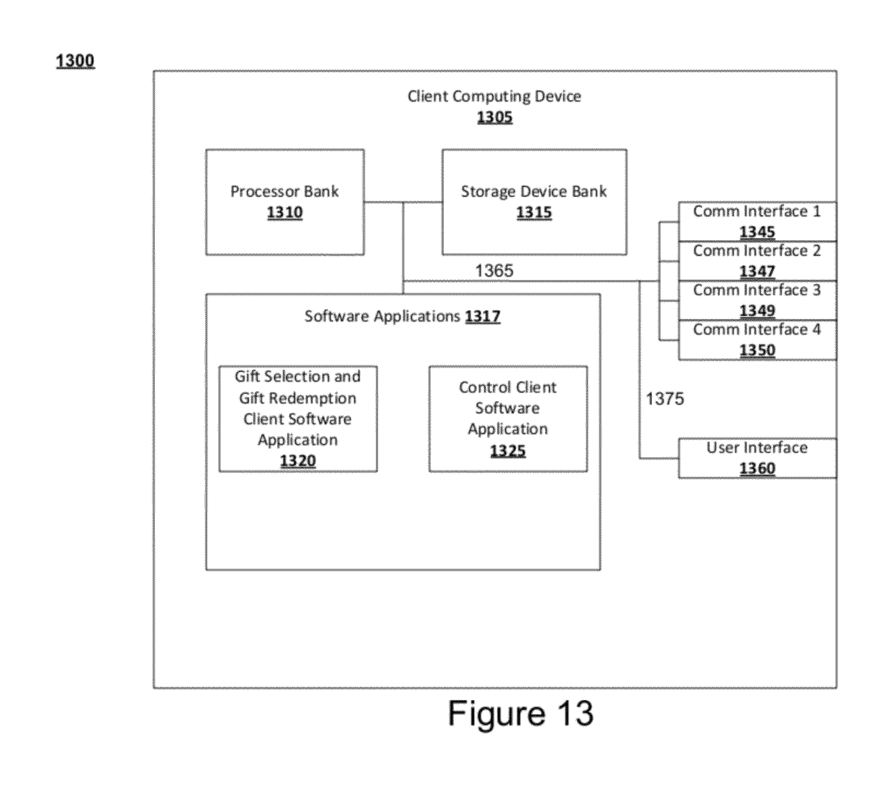

FIG. 13 is a functional block diagram 1300 of an exemplary client computing device 1305 that may be used in an exemplary system for providing gift selection and gift redemption services in an e-commerce environment over a communication network. The client computing device 1305 may include several different components such as a processor bank 1310, storage device bank 1315, one or more software applications 1317, and one or more communication interfaces (1345-1360) and a user interface 1360. The processor bank 1310 may include one or more processors that may be co-located with each other or may be located in different parts of the client device 1305. The storage device bank 1315 may include one or more storage devices. Types of storage devices may include memory devices, electronic memory, optical memory, and removable storage media. The one or more software applications 1317 may include a gift selection and gift redemption client software application 1320 and a control client software application 1325.

The gift selection and gift redemption client software application 1320 may receive web pages and or other data from a computer server that is part of an exemplary system for providing gift selection and gift redemption services in an e-commerce environment over a communication network. The gift selection and gift redemption client software application 1320 allows a gift donor, using the client device 1305 and user interface 1360, to select a gift or gift option for gift recipient based on gift recipient attributes as well as gift experience attributes (collectively may be called gift attributes) as discussed in the present disclosure and client software applications 1320 may assist in constructing a gift reveal for the selected gift or gift option. Alternatively, the gift selection and gift redemption client software application 1320 allows a gift recipient, using the client device 1305, to enter the gift redemption code and experience the gift reveal as well view an image and description of the gift selected by the gift donor. Further, the gift recipient may download the gift to the client device 1305 or have an option to ship the gift to the gift recipients residence depending on the type of gift or preference of the gift recipient.

The control client software application 1325 may implement software functions that facilitate the functions of the client computing device such as displaying web pages as well receiving and providing data to the communication interfaces (1345-1350). In addition, the control client software application 1325 may provide other functions for the client device 1305 to perform client device tasks. Person of ordinary skill in the art would understand that the software functions described as separate software applications (1320-1325) may be combined or separated into one or more software applications.

Each of the communication interfaces (1345-1350) shown in FIG. 13 may be software or hardware associated in communicating to other devices or to a client device user. The communication interfaces (1345-1350) may be of different types that include a user interface, USB, Ethernet, WiFi, WiMax, wireless, optical, cellular, or any other communication interfaces coupled to a communication network. One of the communication interfaces (1345-1350) may be a communication interface which may be coupled to a computer server over a communication network. Further, user interface 1360 may be an input/output device such as a keyboard with display, touchscreen or other some other type of user interface known to those of ordinary skill in the art.

Intra-device communication links (1365 and 1375) between the processor bank 1310, storage device bank 1315, software applications 1317, communication interfaces (1345-1350), and user interface 1360 may be one of several types that include a bus or other communication mechanism.

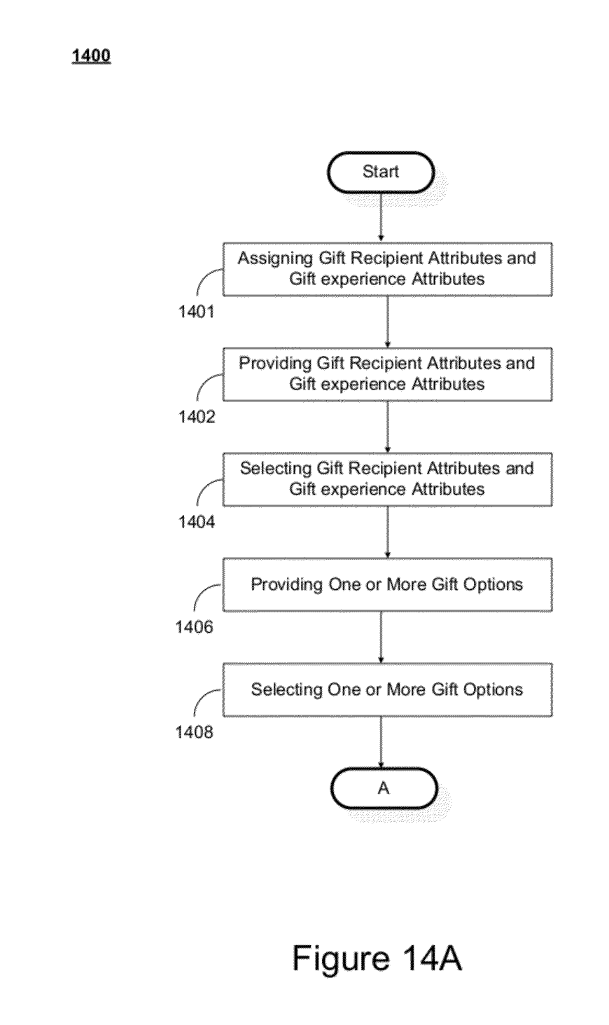

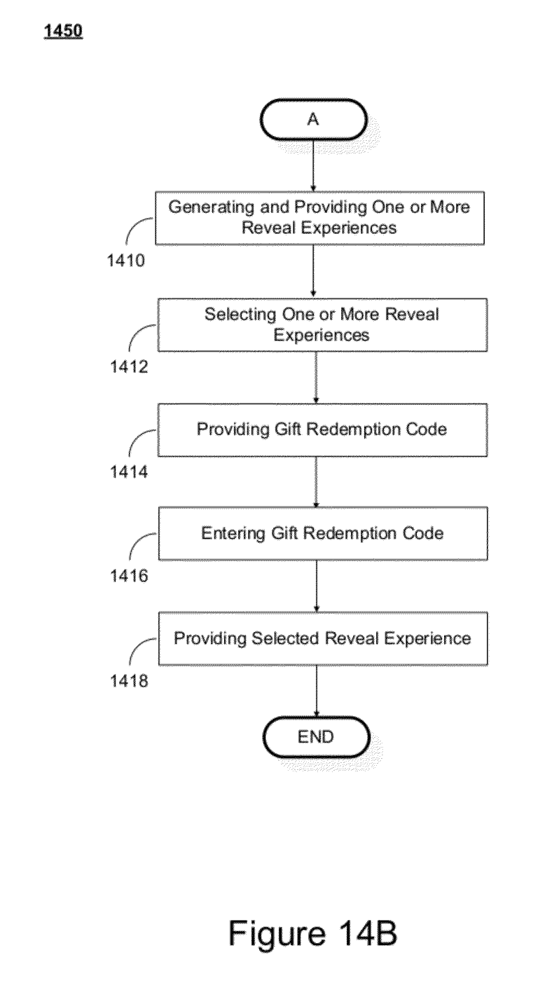

FIGS. 14A-B are flow charts (1400 and 1450) of exemplary methods for providing gift selection and gift redemption services in an e-commerce environment over a communication network. A step in an exemplary method may be assigning one or more gift recipient attributes and one or more gift experience attributes to each of one or more gift options, as shown in block 1401. Gift options are gifts that may be selected by a gift donor accessing a gift selection and gift redemption process in an e-commerce environment over a communication network. An image and description associated with a gift option may be stored in a database which in turn is stored in a storage device bank of a computer server as well as gift option's associated gift recipient attributes and gift experience attributes. A further step in the exemplary method may be providing one or more gift recipient attributes and one or more gift experience attributes to a gift donor on a user interface of a client device by a computer sever through a communication interface over a communication network, as shown in block 1402. A client device communication interface may be a communication interface on the server that is coupled to a client device across a communication network. The gift recipient attributes may include the relationship of the gift donor with the gift recipient (spouse, father, mother, etc.) or the type of activities the gift recipient is interested such as sports, movies, books, outdoors, etc (See FIG. 2A for examples of gift recipient attributes). Alternatively, gift experience attributes may be attributes that indicate the feeling a gift recipient may enjoy in viewing the gift. Such attributes may include romantic, adventurous, holiday, etc. (See FIG. 2B for examples of gift experience attributes). The gift recipient attributes and gift experience attributes may be listed on the user interface of the client device as a web page hosted by the computer server. Alternatively, the gift recipient attributes and gift experience attributes may be displayed on the client device in conjunction with software applications residing on the computer server.

An additional step in the exemplary method may be selecting one or more gift recipient attributes and one or more gift experience attributes by a gift donor using the client device, as shown in block 1404. Specifically, the gift donor may select gift recipient attributes and gift experience attributes on web page (See FIG. 2A). Another step in the exemplary method may be providing one or more gift options using a matching software engine or application based on the one or more gift recipient attributes and one or more gift experience attributes selected by a gift donor, as shown in block 1406. The computer server may receive the selected gift recipient attributes and gift experience attributes from the client device across a communication interface. A matching algorithm, known to persons of ordinary skill in the art as well as matching algorithms discussed in the present disclosure, may be implemented by a matching software engine and provide gift options designated as matches based on the gift recipient attributes and gift experience attributes and a matching threshold. The gift options may be listed on a web page hosted by the computer server communicated to the client device over the communication interface coupled to the client device and displayed on the user interface of the client device (See FIG. 3). A further step in the exemplary method may be selecting one or more gift options by a gift donor from the web page listing the gift options, as shown in block 1408.

Referring to FIG. 14B, an additional step in the exemplary method may be generating and providing one or more reveal experiences to the gift donor, as shown in block 1410. The reveal experiences may be listed on a web page shown on the gift donor's client device and hosted by the computer server. Another step may be the gift donor selecting one or more reveal experiences listed on a web page (See FIG. 4), as shown in block 1412. A further step in the exemplary method may be providing a gift redemption code associated with the selected gift option and the selected reveal experience from a computer server to a client device, as shown in block 1414 (See FIG. 6). The gift donor may provide the gift redemption code to the gift recipient. Moreover, the gift recipient may access a website hosted by the computer server from a client device. The computer server may provide a web page to be displayed on the client device user interface allowing the gift recipient to enter the gift redemption code (See FIG. 7). The gift recipient may enter the gift redemption code into a dialog box or some other mechanism into the web page, as shown in block 1416. The client device communicates the gift redemption code to the computer server to be processed. An additional step in the exemplary method may be providing the selected reveal experience to the gift recipient based on the gift redemption code, as shown in block 1418. The gift reveal may be presented to the gift recipient on a user interface of the client device as a series of web pages hosted and provided by a computer server to the client device through a communication interface. At the conclusion of the gift reveal, the gift option selected by the gift donor may be presented to the gift recipient.

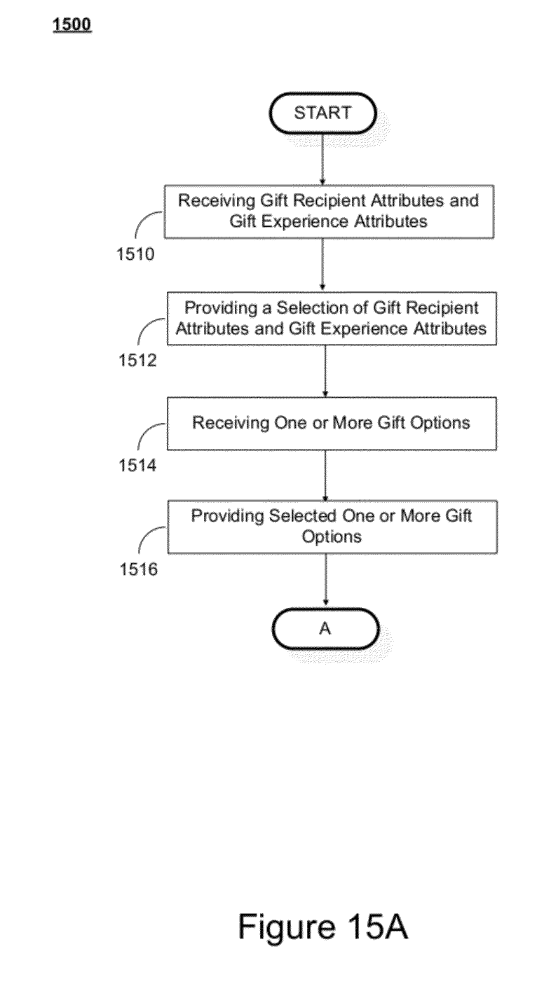

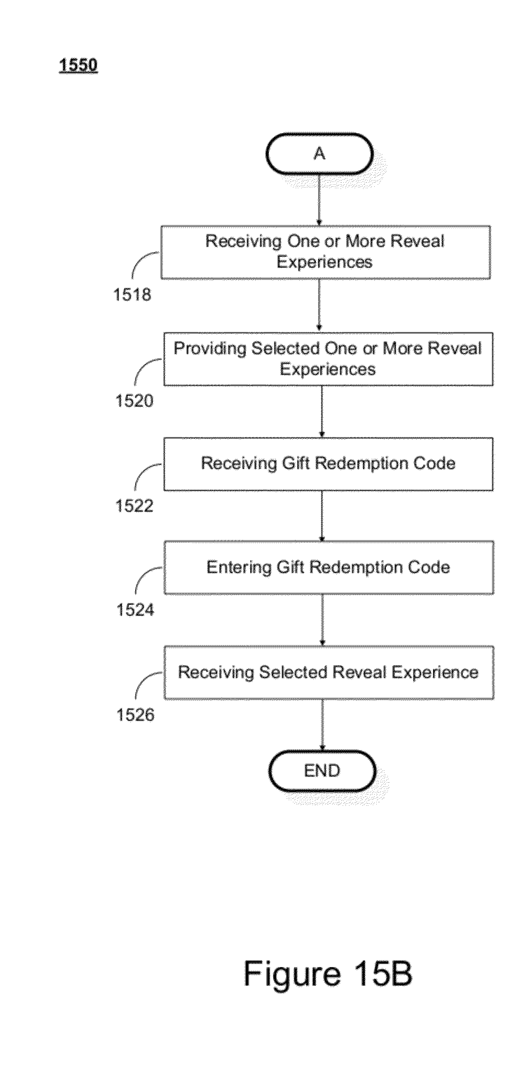

FIG. 15A-B are flow charts (1500 and 1550) of an exemplary methods for providing gift selection and gift redemption services in an e-commerce environment over a communication network. A step in the exemplary method may be receiving one or more gift recipient attributes and one or more gift experience attributes from computer server through a communication interface on a client device, as shown in block 1510. The client device may display the attributes on a web page on the user interface of the client device. A further step in the exemplary method may be providing a selection of one or more gift recipient attributes and one or more gift experience attributes to the communication interface on the client device using the user interface, as shown in block 1512. Thus, a gift donor may select one or more attributes listed on a web page displayed on a client device user interface. Further, the client device may forward the selected attributes and any associated data to the communication interface coupled to the computer server (over the communication network). An additional step in the exemplary method may be receiving one or more gift options from the communication interface on the client device, as shown in block 1514. The client device may list the one or more gift option on a web page displayed on the client device user interface. The gift donor may select one or more gift options listed on the web page. Another step in the exemplary method may be providing one or more selected gift options to the communication interface coupled to the computer server, as shown in block 1516.

Referring to FIG. 15B, a further step in the exemplary method may be receiving one or more reveal experiences from the communication interface coupled to the computer server on the client device, as shown in block 1518. The client device may list the one or more reveal experiences on a web page on the client device user interface. A gift donor may select one or more reveal experiences listed on the web page. An additional step in the exemplary method may be providing one or more selected reveal experiences to the communication interface, as shown in block 1520. Another step in the exemplary method may be receiving a gift redemption code based on the selected gift option and the selected reveal experience from the communication interface on the client device, as shown in block 1522. The gift redemption code may be listed on a web page displayed on the user interface of the client device. A further step in the exemplary method may be a gift recipient entering the gift redemption code in a dialog box on a web page and providing the gift redemption code to the communication interface on a client device, as shown in block 1524. The client device may be the same client device used by the gift donor but may also be different client device, either of which used by the gift recipient. An additional step in the exemplary method may be receiving the selected reveal experience from the communication interface based on the gift redemption code and displaying the selected reveal experience as a series of web pages on the client device user interface, as shown in block 1526.

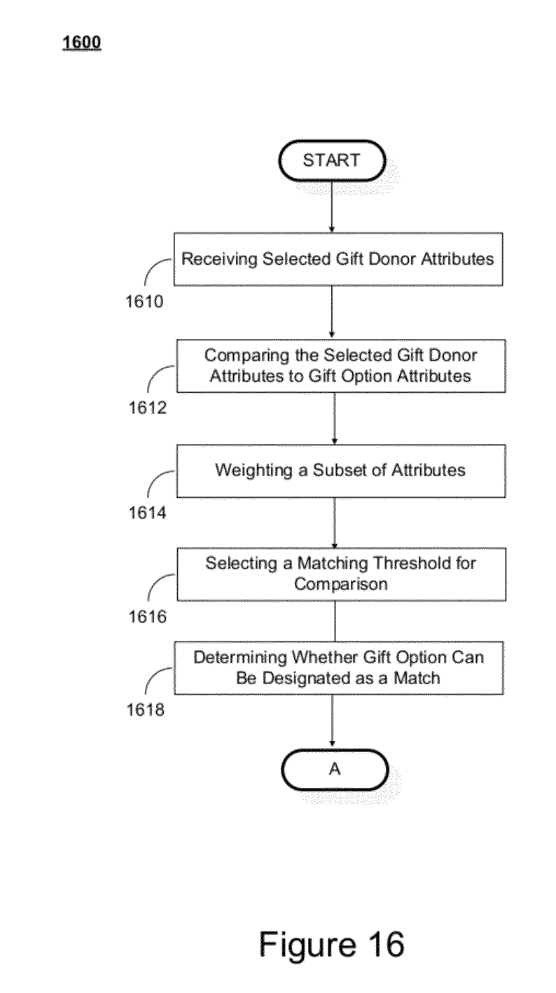

FIG. 16 is a flow chart 1600 of an exemplary method for matching gift options with selected gift attributes to be used in a method for providing gift selection and gift redemption in an e-commerce environment over a communication network. A step in the exemplary method may be receiving one or more selected gift recipient attributes and gift experience attributes selected by a gift donor by a matching software engine residing on a computer server, as shown in block 1610. A further step in the exemplary method may be comparing the selected gift attributes to the attributes of one or more gift options, as shown in block 1612. An additional step in the exemplary method may be weighting a subset of attributes, as shown in block 1614, because such a subset of attributes may be more significant to provide a better experience to a gift recipient when the gift is revealed. Another step in the exemplary method may be selecting a matching threshold for comparing the attributes selected by the gift donor to attributes of each gift option, as shown in block 1616. A further step in the exemplary method may be determining whether a gift option can be designated as a match, as shown in block 1618. A match may be determined by processing the gift attributes selected by the gift donor and comparing the selected gift attributes to the gift attributes of one or more gift options in a gift database. Further a matching threshold may be determined such that if the number of selected attributes that are in common to the gift attributes of a gift option exceeds the matching threshold, then the gift option is designated as a match.

For example, a gift donor may choose gift recipient attributes such as wife, dining, and traveling, and gift experience attributes such as romantic and adventure. After receiving such attributes, the matching software engine may compare these attributes with the attributes of each gift option in the gift option database stored in the storage device bank of a computer server. Further, the matching threshold programmed in the matching software engine may be a matching threshold value equal to 2. That is, when at least two attributes of a gift option match the attributes selected by the gift donor, then the gift option is designated as a match. Persons of ordinary skill in the art would understand that the matching threshold may not be an absolute number but may be obtained using matching algorithms known in the art. As an example, the matching threshold may be a percentage (40%) of the number of attributes selected by the gift donor. Consequently, in the previous example where there are five selected gift attributes selected are wife, dining, traveling, romantic and adventure, the matching software engine may designate a gift option as a match when at least two gift attributes associated with a gift option in the associated database match the selected gift attributes.

Further alternative embodiments may include incorporating user feedback in implementing matching software engine. For example, the user feedback may include a rating for a gift option on a scale of 1 to 5. A user rating equal to 1 may decrease the number of matched attributes by 2 or the percentage of match by 10 percentage points. Conversely, a user rating equal to 5 may increase the number of matched attributes by 2 or the percentage of match by 10 percentage points. A further example may be that a fondue pot matches 3 out of 4 attributes selected by a user for a matching value of 75%. A matching threshold may be 50% such that any gift with a matching value equal to or greater than 50% is shown in matching value descending order (highest matching value to lowest matching value). A matching software engine may incorporate user feedback in the following manner. If user feedback regarding the fondue pot is equal to 1 (from a scale of 1 to 5) then the matching value is decreased by 10 percentage points from 75% to 65%. Alternatively, if the user feedback rating is equal to 5 then the matching software engine may add 10 percentage points to the matching value from 75% to 85%.

Alternative embodiments may also incorporate other information into a matching algorithm as would be known by a person of ordinary skill in the art. Such other information may include information obtained from other sources and having more complex information. For example, third party data from social media providers, streaming video providers, and online retailers. Such type of data could include different types of online activity information such as movies/tv watched, previous purchases, etc. Based on such information, a matching algorithm may be able to list potential gift options that can be selected by the gift donor for the gift recipient. A gift selection and reveal provider may also incorporate information regarding previous dealings or purchases made by the gift recipient into the matching algorithm.

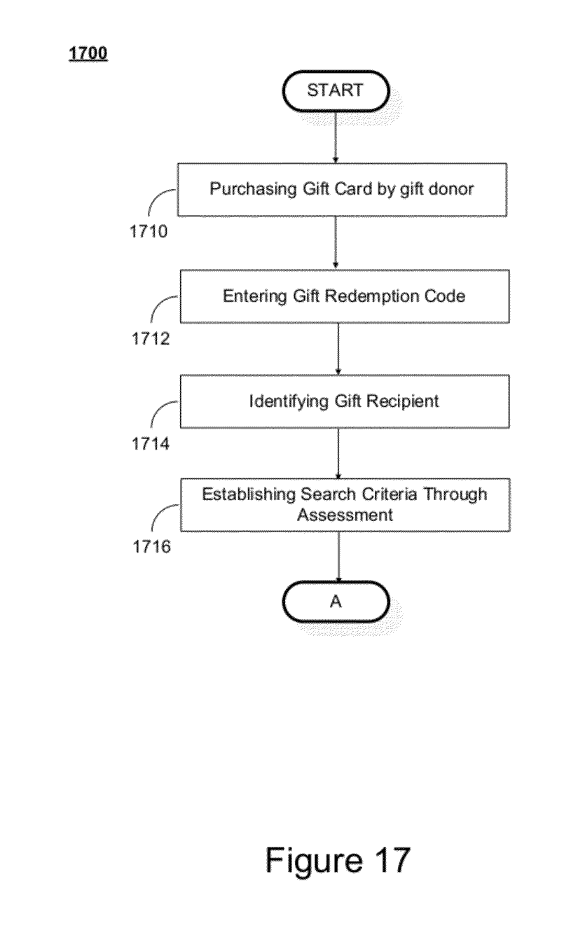

FIG. 17 is a flow chart of an alternative exemplary method for providing gift selection and gift redemption in an e-commerce environment over a communication network. In an alternative embodiment of the present disclosure, a gift donor may purchase a gift card having a gift redemption code from a gift card retailer or other such entity, as shown in block 1710. An exemplary method within the embodiment may include a gift donor giving and a gift recipient receiving the gift card. Thereafter, the gift donor may enter the gift redemption code into a gift recipient client computing device to redeem the gift card. In a further step, the gift recipient provides identifying information to a client software application residing on the gift recipient client computing device that may include name and address, as shown in block 1714. Such information is forwarded to a computer server that may use the information in gift selection or redemption. An additional step in the method may include establishing a search criteria for selecting a gift and/or reveal through assessment of the gift recipient and/or the gift donor(s), as shown in block 1716.

The assessment may include a gift donor selecting one or more gift recipient attributes or gift experience attributes (See FIGS. 2A and 2B). Further, search criteria may include querying the gift donor with questions and providing one or more selections to respond to the queries. For example, the search criteria embodied in a client software program running on a client computing devices and on the device web browser, may query for the gift recipient's age, gender, and address. Such queries may elicit gift recipient attributes for the search criteria. Further queries may ask the gift recipient's familial relationship to the gift donor (e.g. sibling, father, mother, grandparent, cousin, niece, nephew). The relationship need not be familial but a social connection such as a friend, hostess, or friend's child, or a mentor such as a teacher, coach, or clergymen as well as a professional or personal service provider such as a coworker, employee, boss, domestic helper doctor, dentist, nurse, and/or babysitter.

Further, the search criteria may query the occasion for purchasing the gift. Such occasions include birthday, anniversary, wedding, graduation, bridal shower, baby shower. Further, the search criteria may query for life events such as new job, new home, new school, new pet, and new baby. Other life events may include rites of passage such as becoming a teen, becoming the parent of a teen, first day of school, religious transitions (e.g. confirmations). Further life events may be illness, divorce, and death. Such a life event may have happened in the past (hence good luck) or will in happy in the future (congratulations) an may include performances, sports achievements, and academic achievements. The search criteria may include querying whether the gift is a gift of gratitude to a one or more individuals such as a teacher, couch, doctor, nurse, or service provider. Another aspect of the embodiment would be querying the gift recipient for a purpose for the gift such as trying something new, identify or extend a passion, play, indulgence, splurge, learning something new, having fun, laugh, being entertained, forgetting troubles, and a holiday occasion.

In addition, the search criteria may query the gift donor on how the gift recipient should feel when opening the gift. Such feelings may be surprise, awe, comfort, understanding, challenged, happy. Other more pointed queries may include asking how a gift recipient may spend two hours of free time. Examples of such activities may include watching a movie (a follow up query may be favorite movie), watching TV (follow up query may be favorite TV show), attending a sporting event, working out, playing music, listening to music, playing video games, doing arts and crafts, building, baking, shopping, play with pet. Other queries may include asking what activities the gift recipient wanted to try such as golfing, running, playing an instrument, learning a new language, traveling, camping, painting, writing. Another query may be what does the gift recipient care about and may include animals, environment, children, eliminating illness (subcategories for type) volunteering when natural disasters occur. Further queries may be what types of gift should be viewed by the gift donor to select and may include products, services, experiences, charitable causes, pairings of one or more thereof.

An alternative embodiment may include a set of software tools and physical packaging mechanisms to improve a gift recipient's experience in redeeming a gift card. Such packaging mechanisms may include sleeves or other types of gift card packaging. Such a packaging mechanism may have a gift donor code and a gift recipient code, each of which may be used by a user to log into a gift selection and redemption web site or server application as described in the present disclosure. A gift donor may purchase a sleeve or other type of gift card packaging and log onto a website, for example. Alternatively, a user may design a sleeve or type of packaging mechanism for the gift card using software design tools on a packaging provider website. Further, the gift donor may select the type of gift card they have in possession (e.g. the type of retailer). In addition, the gift donor may establish a search criteria through an assessment as described in the present disclosure. Alternative embodiments may have the search criteria limited to the type of retailer or to any type of retailer.

Another alternate embodiment may include allowing vendors of products, services, etc. to code the respective vendors' products, services, etc. based on variables determined by a gift selection and redemption provider. Variables are derived from the responses from queries given to a gift donor or gift recipient during the search criteria assessment. The gift selection and redemption provider may have a software platform with an application programming interface (API) that may allow vendors to generate suggested gift experience attributes or reveal experiences with their respective product or service. Such gift experiences and reveal experiences may be associated with respective vendor products, services, etc. in a database.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases “one or more” or “at least one” and indefinite articles such as “a” or an (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A system for providing gift selection and gift redemption services in an e-commerce environment over a communication network, the system comprising:
(a) a computer server having one or more server communication interfaces coupled to the communication network and one or more server processors coupled to one or more server storage devices, the computer server having;
(i) a selection software engine stored in the one or more server storage devices and executed by one or more server processors, the selection software engine (1) providing one or more gift recipient attributes and one or more gift experience attributes to a gift donor communication interface; and (2) receiving one or more donor selected gift recipient attributes and one or more donor selected gift experience attributes from the gift donor communication interface.
(ii) a matching software engine stored in the one or more server storage devices and executed by one or more server processors, the matching software engine providing one or more matched gift options based on the donor selected gift recipient attributes and the donor selected gift experience attributes to the gift donor communication interface;
(iii) a reveal software engine stored in the one or more server storage devices and executed by one or more server processors, the reveal software engine (1) receiving one or more selected matched gift options from a gift donor communication interface; (2) generating and providing one or more reveal experiences to the gift donor communication interface; (3) receiving one or more selected reveal experiences from the gift donor communication interface; and (4) providing a gift redemption code based on the one or more selected matched gift options and the selected reveal experience to the gift donor communication interface;
(iv) a redemption software engine stored in the one or more server storage devices and executed by one or more server processors, the redemption software engine (1) receiving the gift redemption code from a gift recipient communication interface; and (2) providing the selected reveal experience to the gift recipient communication interface based on the gift redemption code;
(v) wherein the gift donor communication interface and the gift recipient communication interface are each one of the one or more server communication interfaces coupled to the communication network;
(b) a gift donor client device having one or more donor client communication interfaces coupled to the communication network, a donor user interface and one or more donor processors coupled to one or more donor storage devices, the gift donor client device: (i) receiving one or more gift recipient attributes and one or more gift experience attributes from a donor-server communication interface; (ii) displaying one or more gift recipient attributes and one or more gift experience attributes on the donor user interface; (iii) receiving one or more donor selected gift recipient attributes and one or more donor selected gift experience attributes from the donor user interface; (iv) providing one or more donor selected gift recipient attributes and one or more donor selected gift experience attributes to the donor-server communication interface; (v) wherein the donor-server communication interface is one of the one or more donor client communication interfaces;
(c) a gift recipient client device having one or more recipient client communication interfaces coupled to the communication network, a recipient user interface and one or more recipient processors coupled to one or more recipient storage devices, the gift recipient client device: (i) receiving a gift redemption code from the recipient user interface; (ii) providing the gift redemption code to the recipient-server communication interface;(iii) receiving the selected reveal experience from the recipient-server communication interface based on the gift redemption code; and (iv) displaying the selected reveal experience on the recipient user interface.

2. The system of claim 1; wherein each of the one or more gift options stored in a database are assigned one or more gift recipient attributes and one or more gift experience attributes.

3. The system of claim 2, wherein
(a) the computer server receives donor selected gift recipient attributes and the donor selected gift experience attributes from the gift donor communication interface; and
(b) the matching software engine provides one or more matched gift options to the gift donor communication interface by comparing the donor selected gift recipient attributes and the donor selected gift experience attributes to the gift recipient attributes and gift experience attributes associated with each of the one or more gift options stored in the database.

4. The system of claim 3, wherein the matching software engine determines:
a first gift option as a first matched gift option by determining the number of donor selected gift recipient attributes and the donor selected gift experience attributes in common with the gift recipient attributes and gift experience attributes of the first gift option is at least equal to a matching threshold
a first gift option as a first matched gift option as a match by determining a percentage of donor selected gift recipient attributes and the donor selected gift experience attributes in common with the gift recipient attributes and gift experience attributes of the first option is at least equal to a percentage matching threshold.

5. The system of claim 3, wherein the gift donor client device (i) receiving one or more matched gift options from the donor-server communication interface; (ii) displaying the one or more matched gift options on the donor user interface; and provides one or more selected matched gift options to the donor-server communication interface.

6. The system of claim 5, wherein gift donor client device (i) receives one or more reveal experiences from the donor-server communication interface; (ii) displays the one or more reveal experiences on the donor user interface; and (iii) receiving one or more one or more selected reveal experiences from the donor user interface; and (iv) providing one or more selected reveal experiences to the donor-server communication interface.

7. The system of claim 6, wherein gift donor client device (i) receives a gift redemption code based on the one or more selected matched gift options and the selected reveal experience from the donor-server communication interface; and (ii) displays the gift redemption code on the donor user interface.

8. The system of claim 1, wherein:
the selection software engine selects a default matched gift option;
the reveal software engine: selects a default reveal and receives a user generated reveal from the gift donor communication interface; and
the matching software engine provides one or more matched gift options based on the donor selected gift recipient attributes, the donor selected gift experience attributes, and user feedback to the gift donor communication interface.

9. A device for providing gift selection and gift redemption services in an e-commerce environment over a communication network, the device comprising:
(a) a computer server having one or more server communication interfaces coupled to the communication network and one or more server processors coupled to one or more server storage devices;
(b) a selection software engine stored in the one or more server storage devices and executed by one or more server processors, the selection software engine (i) providing one or more gift recipient attributes and one or more gift experience attributes to a gift donor communication interface; and (ii) receiving one or more donor selected gift recipient attributes and one or more donor selected gift experience attributes from the gift donor communication interface.
(c) a matching software engine stored in the one or more server storage devices and executed by one or more server processors, the matching software engine providing one or more matched gift options based on the donor selected gift recipient attributes and the donor selected gift experience attributes to the gift donor communication interface;
(d) wherein the gift donor communication interface is one of the one or more server communication interfaces coupled to the communication network.

10. The device of claim 9, the device further comprising a reveal software engine stored in the one or more server storage devices and executed by one or more server processors, the reveal software engine:
(i) receiving one or more selected matched gift options from the gift donor communication interface;
(ii) generating and providing one or more reveal experiences to the gift donor communication interface;
(iii) receiving one or more selected reveal experiences from the gift donor communication interface; and
(iv) providing a gift redemption code based on the one or more selected matched gift options and the selected reveal experience to the gift donor communication interface.

11. The device of claim 10, the device further comprising a redemption software engine stored in the one or more server storage devices and executed by one or more server processors, the redemption software engine:
(i) receiving the gift redemption code from a gift recipient communication interface; and
(ii) providing the selected reveal experience to the gift recipient communication interface based on the gift redemption code;
(iii) wherein the gift recipient communication interface is one of the one or more server communication interfaces coupled to the communication network.

11. The device of claim 10, wherein each of the one or more gift options stored in a database are assigned one or more gift recipient attributes and one or more gift experience attributes.

12. The device of claim 11, wherein:
(a) the computer server receives donor selected gift recipient attributes and the donor selected gift experience attributes from the gift donor communication interface; and
(b) the matching software engine provides one or more matched gift options to the gift donor communication interface by comparing the donor selected gift recipient attributes and the donor selected gift experience attributes to the gift recipient attributes and gift experience attributes associated with each of the one or more gift options stored in the database.

13. The device of claim 12, wherein the matching software engine determines a first gift option a first gift option as a first matched gift option by determining the number of donor selected gift recipient attributes and the donor selected gift experience attributes in common with the gift recipient attributes and gift experience attributes of the first gift option is at least equal to a matching threshold.

14. A method for providing gift selection and gift redemption services in an e-commerce environment over a communication network, the method comprising:
(a) providing one or more gift recipient attributes and one or more gift experience attributes to a gift donor communication interface coupled to computer server; and
(b) receiving one or more donor selected gift recipient attributes and one or more donor selected gift experience attributes from the gift donor communication interface.
(c) providing one or more matched gift options based on the donor selected gift recipient attributes and the donor selected gift experience attributes to the gift donor communication interface.

15. The method of claim 14, the method further comprising:
(a) receiving one or more gift recipient attributes and one or more gift experience attributes from a donor-server communication interface coupled to a gift donor client device;
(b) displaying one or more gift recipient attributes and one or more gift experience attributes on a donor user interface coupled to the gift donor client device;
(c) receiving one or more donor selected gift recipient attributes and one or more donor selected gift experience attributes from the donor user interface;
(d) providing one or more donor selected gift recipient attributes and one or more donor selected gift experience attributes to the donor-server communication interface.

16. The method of claim 15, the method further comprising:
(a) receiving one or more matched gift options based on the donor selected gift recipient attributes and the donor selected gift experience attributes from the donor-server communication interface;
(b) displaying one or more matched gift options based on the donor selected gift recipient attributes and the donor selected gift experience attributes on the donor user interface;
(c) receiving one or more selected matched gift options from the donor user interface;
(d) providing one or more selected matched gift options to the donor-server communication interface;
(e) receiving one or more selected matched gift options from a gift donor communication interface;
(f) generating and providing one or more reveal experiences to the gift donor communication interface;
(g) receiving one or more selected reveal experiences from the gift donor communication interface; and
(h) providing a gift redemption code based on the one or more selected matched gift options and the selected reveal experience to the gift donor communication interface.

17. The method of claim 16, the method further comprising:
(a) receiving a gift redemption code from a recipient user interface coupled to a gift recipient client device;
(b) providing the gift redemption code to the recipient-server communication interface coupled to the gift recipient client device;
(c) receiving the gift redemption code from a gift recipient communication interface; and
(d) providing the selected reveal experience to the gift recipient communication interface based on the gift redemption code;
(e) receiving the selected reveal experience from the recipient-server communication interface based on the gift redemption code and;
(f) displaying receiving the selected reveal experience on the recipient user interface.

18. The method of claim 14, the method further comprising assigned one or more gift recipient attributes and one or more gift experience attributes to each of the one or more gift options stored in a database.

19. The method of claim 14, the method further comprising providing one or more matched gift options to the gift donor communication interface by comparing the donor selected gift recipient attributes and the donor selected gift experience attributes to the gift recipient attributes and gift experience attributes associated with each of the one or more gift options stored in the database.

20. The method of claim 14, the method further comprising determining a first gift option as a first matched gift option by determining the number of donor selected gift recipient attributes and the donor selected gift experience attributes in common with the gift recipient attributes and gift experience attributes of the first gift option is at least equal to a matching threshold.
